(19) United States
(12) Patent Application Publication
(10) Pub. No.: US 2018/0323737 A1
(43) Pub. Date: Nov. 8, 2018

(54) SCALABLE ELECTRIC GENERATOR

(71) Applicant: ATELTECH AS, Høvik (NO)

(72) Inventor: Appan MASILLAMANI, Høvik (NO)

(21) Appl. No.: 15/773,792

(22) PCT Filed: Nov. 7, 2016
(86) PCT No.: PCT/NO2016/050220

§ 371 Date: May 4, 2018

(30) Foreign Application Priority Data
Nov. 6, 2015 (NO) 20151506
May 3, 2016 (NO) 20160741

(51) Int. Cl. H02P 9/00; H02K 7/18; F03D 9/25

(52) U.S. Cl. CPC H02P 9/008; H02K 7/183; H02P 2101/15; H02K 2213/09; F03D 9/25

(57) ABSTRACT

A method, system and device for an electric generator comprising dynamically selectable number of generator disk assemblies.

The present invention relates to electric generators, and more specifically to any type of applications able to generate electric power, utilizing a direct driven electric generator.

It is a common approach in for example the wind turbine industry to custom design gear boxes according to the power and speed requirements. It is thus a problem for the industry that in many wind power generation applications the additional gear boxes increase the weight and the number of moving parts in the turbines. To overcome such a drawback direct drive turbine solutions are typically used in the industry, however even in direct drive turbines the size increases for generation of power more than 6-7 MW, and this becomes a limiting factor, and the feasibility to use this approach becomes impractical.

The gear box increase the overhead power consumption in the generator compared to a direct driven turbine, whilst a direct driven turbine must be formatted to maximum power generation, hence impractical for power generation of more than 6-7 MW due to size and weight constraints.

It is therefore a technical problem in prior art that turbines have too much power overhead for power generation above a certain power level, typically 6-7 MW.

It is therefore an aim of the present invention to provide an electrical power generator solving the above stated technical problem, optimized for use in wind mill power generation, with less power overhead. The present invention may well be used for other power generation application, as well as any power ranges, also when power levels are below 6-7 MW.

The present invention provides an armature-rotor assembly comprising a generator disc stack without a centrally arranged shaft through the generator. The disc stack is comprised of one or more disc assemblies, comprising both a generator stator and generator rotor, wherein the number of spinning/active rotors is dynamically adapted to the actual power source available, such as wind speed.

The electric generator disc comprises stationary armature windings protruding outwards from the circumferential edge of the stator disc. The rotor, being the rotating element is arranged to encircle the stator disc, and comprises strong electro magnets protruding inwards towards the disc armature windings. The arrangement of the magnets in the rotor is alternated with north and south poles respectively facing the stator throughout the entire circumference of the rotor ring. When a mechanical force is applied to the rotor, such as wind casing wind mill turbine blade to rotate, causing the rotor to spin and in turn generates electrical energy in the windings of the non-rotating armature.

It is further an aim of the invention to provide a generator assembly comprising a plurality of generator disc assemblies, each disc assembly comprising an armature arrangement, a rotor and a control system. The complete generator assembly of the electric generator may include ‘n’ number of generator disc assemblies in a disc stack matching the mechanical rotational force of for example a turbine potentially available to drive the rotor discs in the assembly.

It is further an aim to provide a flexible power generation profile by selective use of the number of rotor disc(s) attached to the generator assembly at any given instant during power generation. This is achieved by adding/reducing active rotor disc(s) such that the generator assembly profile match the mechanical power profile available for the turbine.

The torsional moment generated by a turbine or the like is harnessed into a shaft arrangement which connects to the active rotor(s). One embodiment of the invention may comprise multiple armature-rotor disc assemblies, wherein these assemblies are stacked together and each disc assembly is in alignment with the neighboring sides generator disc assemblies. The group of stacked armature disc assemblies may be held together by means of bolts running through prefabricated holes in the stator disc at appropriate intervals. At the peripheral end of the disc stack an end plate may be attached to the rotor stack. The end plate may be of the same circular configuration as the side relief of the disc stack, and may further comprise foundation for a centrally fixed, or integrally mounted, and outwardly protruding shaft. The shaft which is coupled to an encapsulating disc, encapsulating parts of the rotor stack, serves to transfer the mechanical force, kinetic energy from the turbine to the rotor stack which upon revolution around the armature at a given regulated speed generates electrical power in the armature coils which may be transferred to a grid, and additionally a small fraction of this generated power may be stored in a charge storage unit.

The term “armature” or “armature windings” in this document comprise the meaning of a set of coil windings, the armature windings collect the electrical current/power generated by the revolving magnetic field from the rotors.

The term “energy storage” and “power source” in this document may comprise the meaning of battery and/or capacitor bank or equivalent storage able to power, or collect power from, the electric generator of the invention.

The term “horizontal and vertical” are used to identify specific parts in the drawing, appearing as being arranged in a horizontal or vertical manner. However these elements is still part of the invention even if they may not be horizontal or vertical respectively if the generator stack is arranged in a random orientation.

The term “stator pole” shall in this document comprise the meaning of the stator pole itself with or without the windings of a coil, such that for example when talking about magnetized stator pole it encompasses also the windings being fed with a current.

Features of the invention are described in the accompanying non-limiting drawings wherein,

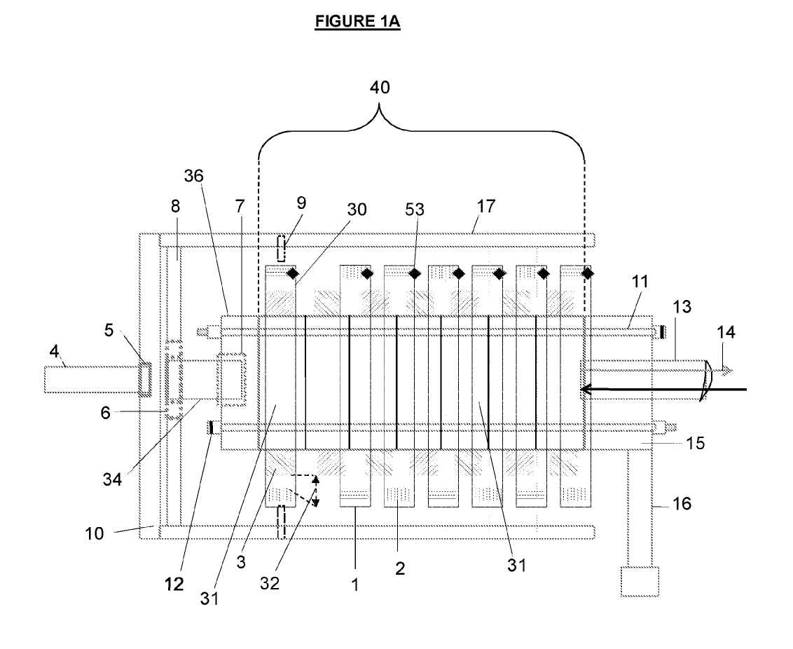

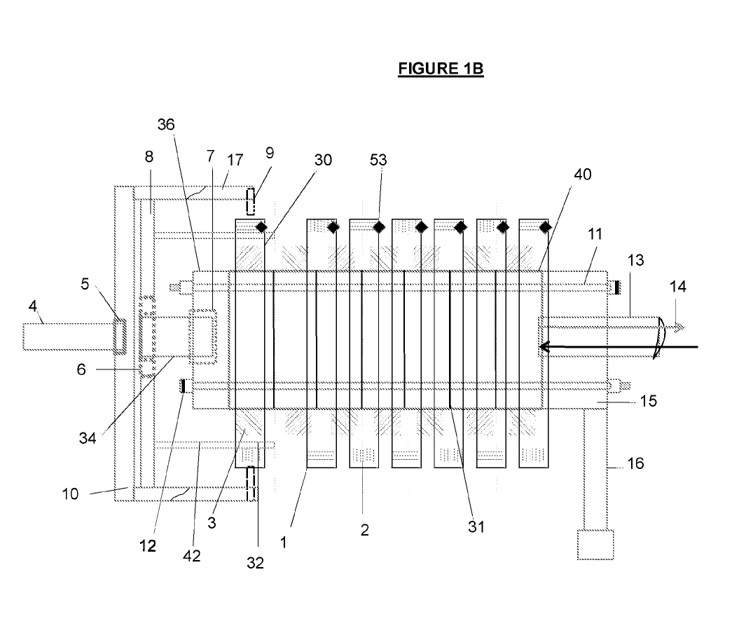

FIGS. 1A and 1B depicts a cross sectional layout of the stacked generator disc assemblies comprising of rotor and armature coils with 2 different embodiments of vertical bar configurations.

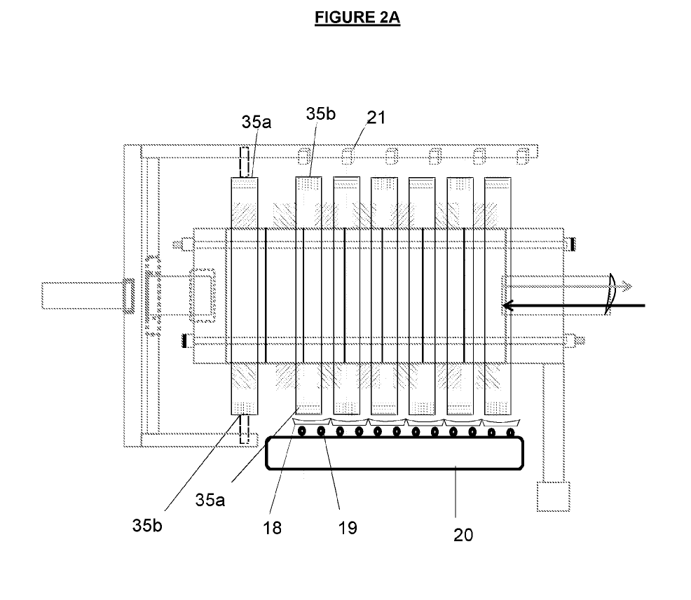

FIGS. 2A and 2B illustrates a cross section view of the stacked generator disc assemblies comprising of rotor and armature coils comprising also a rotor conveyor arrangement, with 2 different embodiments of vertical bar configurations;

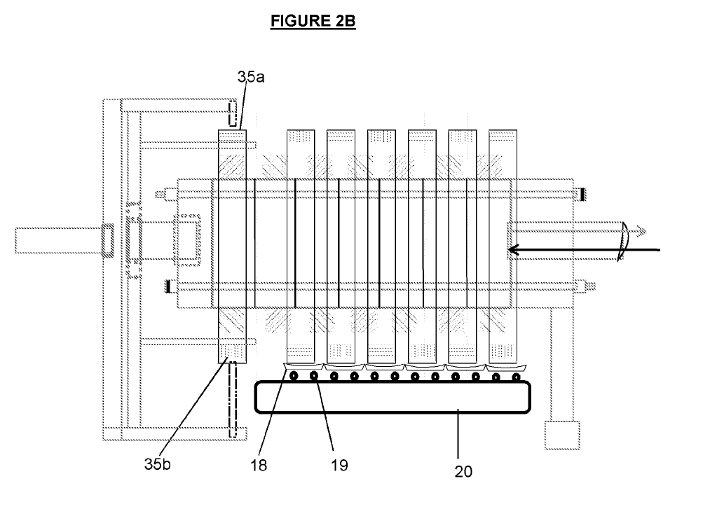

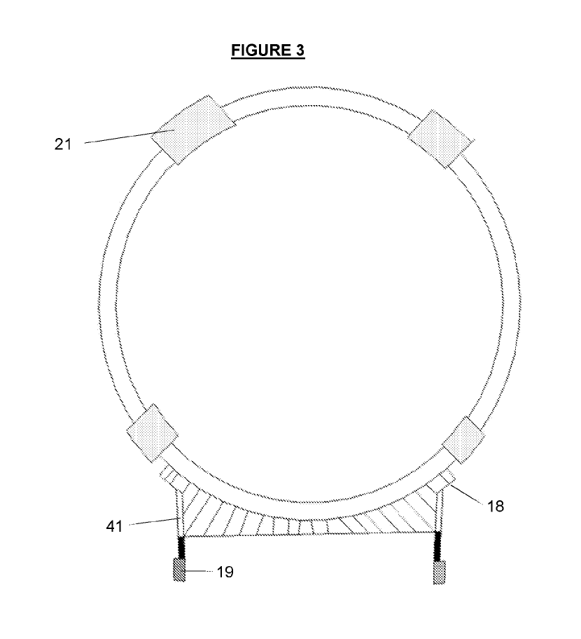

FIG. 3 shows the side view of a rotor positioning mechanism comprising carrier and clamps.

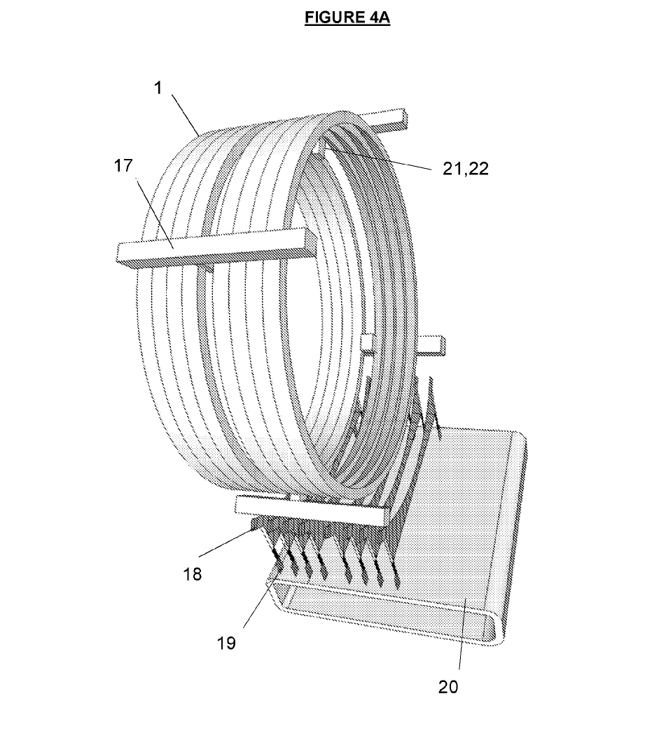

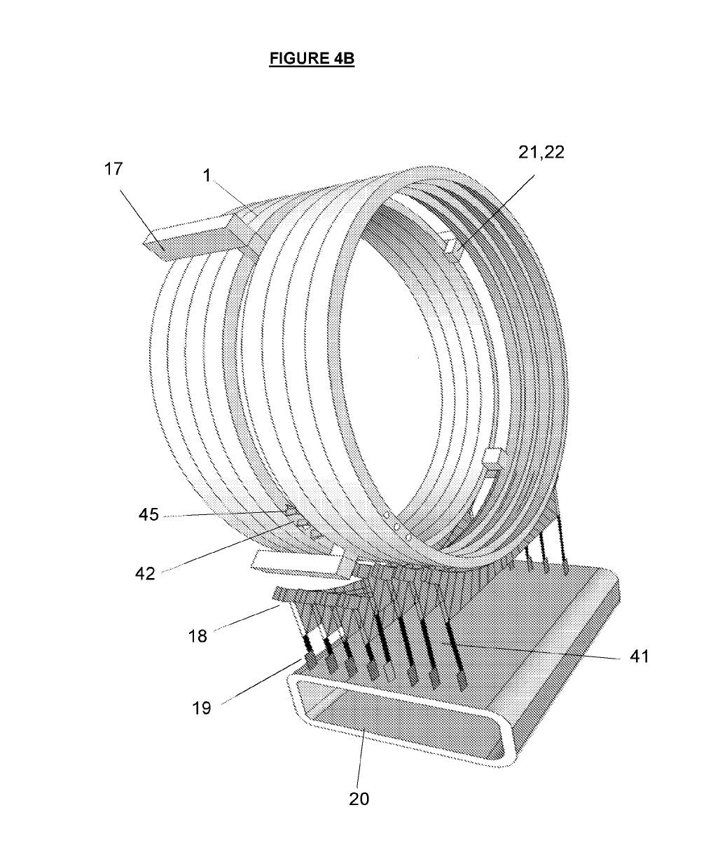

FIGS. 4A and 4B shows a simplified 3D view of the conveyor and holding bars of active/passive rotor discs, with 2 different embodiments of vertical bar configurations.

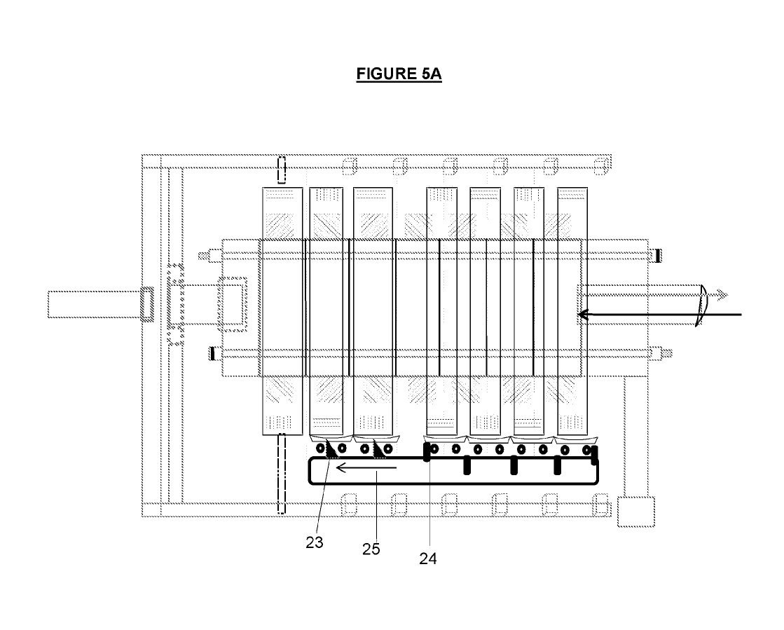

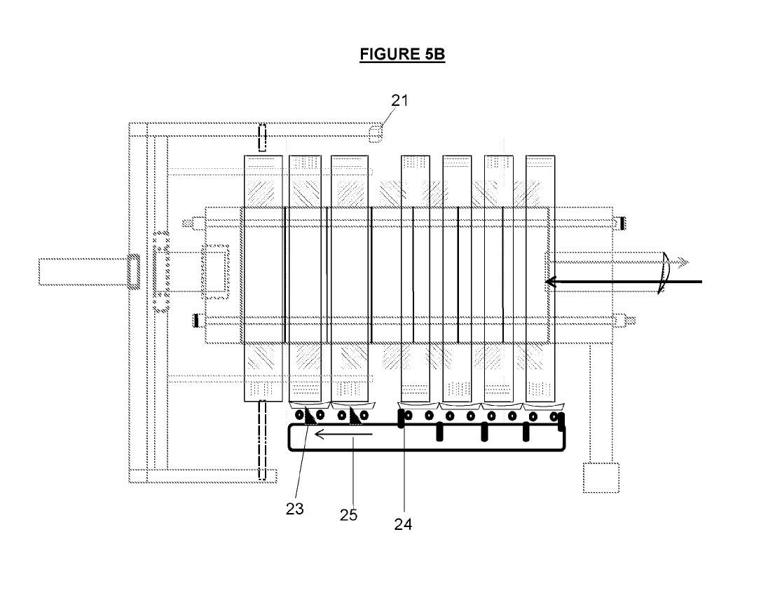

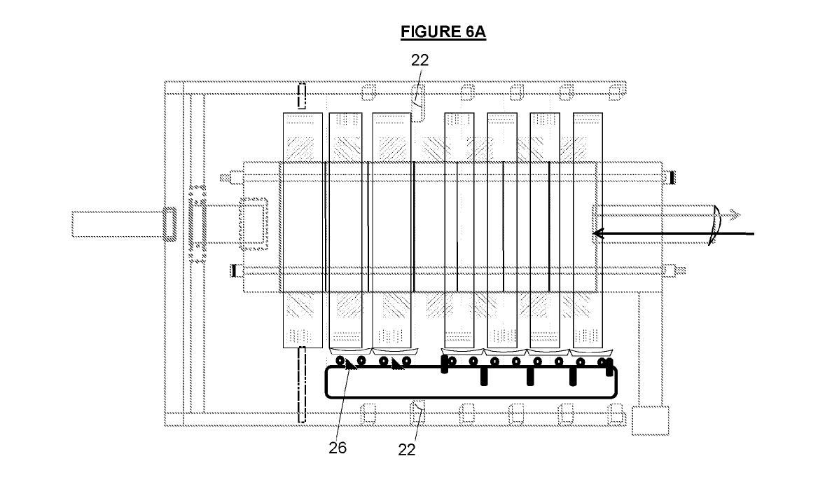

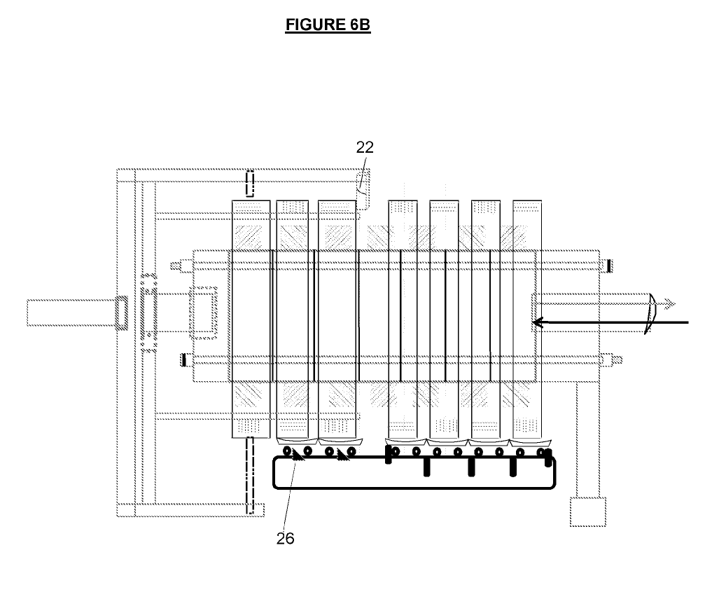

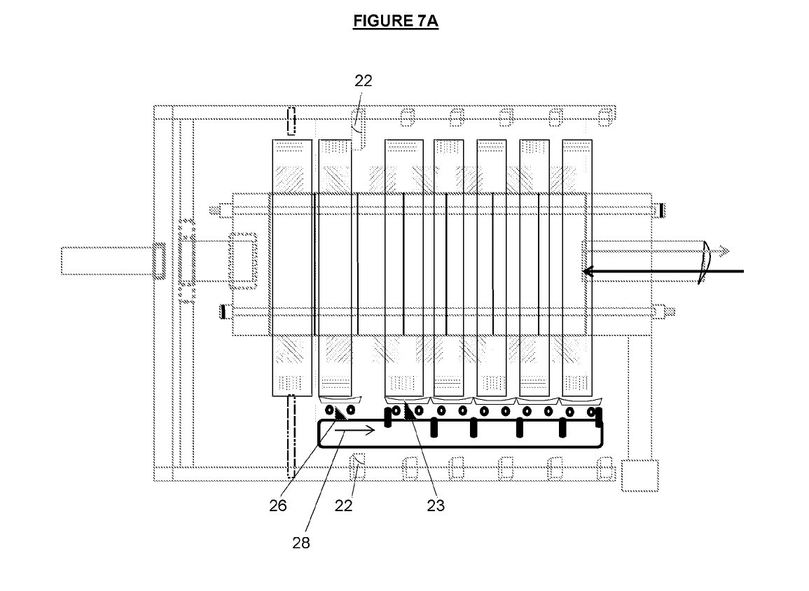

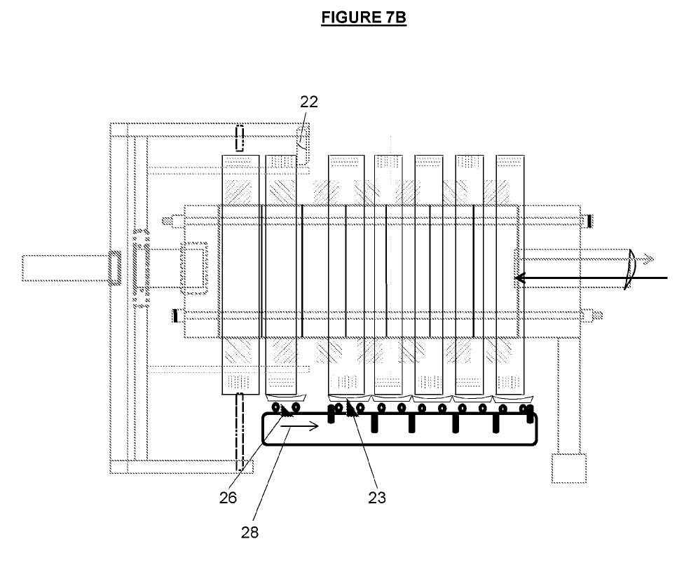

FIGS. 5A-7A and 5B-7B shows the sequence of the adding (FIGS. 5 & 6) or reducing (FIG. 7) the number of the rotor disc(s) being active in the generator assembly, with 2 different embodiments of vertical bar configurations.

FIG. 8 shows the block diagram of the operational process of the generator involving control of the addition or removal of rotor discs with respect to the turbine speed.

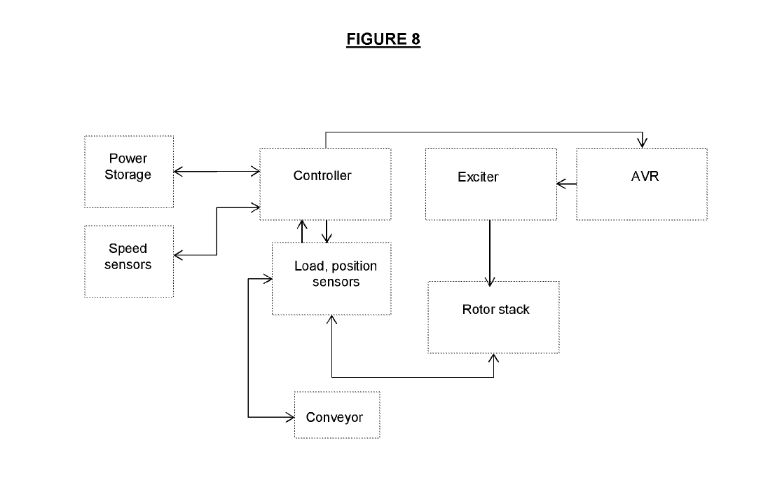

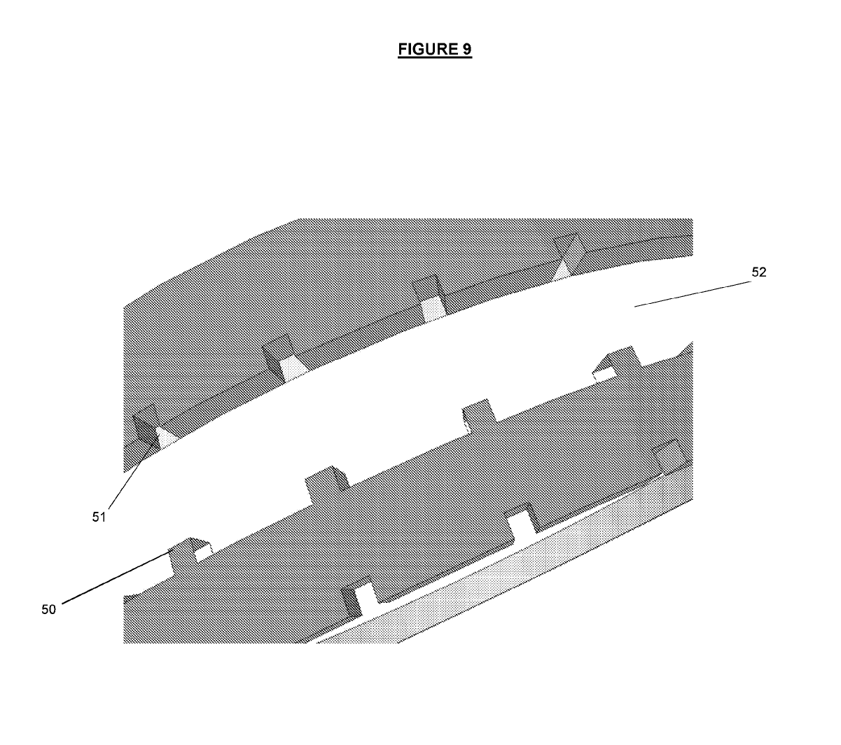

FIG. 9 shows an enlarged view of fitting joints that may be used to affix adjacent rotor disc frames in place.

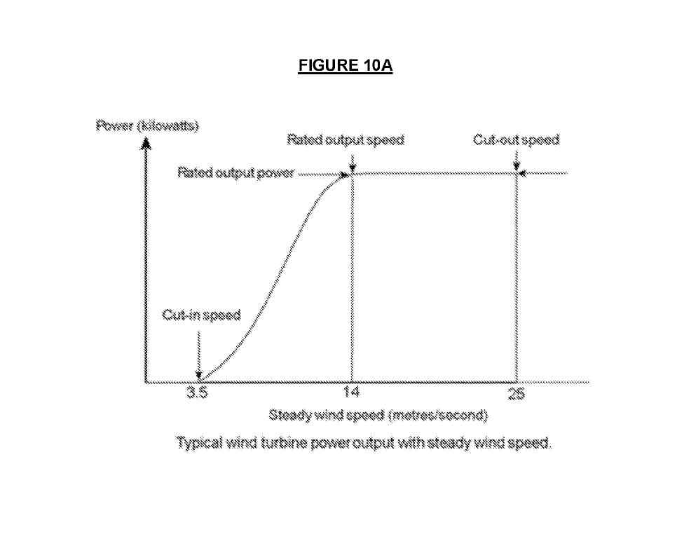

FIG. 10A Shows a diagram for typical wind turbine output with steady wind speed.

FIG. 10B Shows a diagram for wind turbine according to the invention output with steady wind speed.

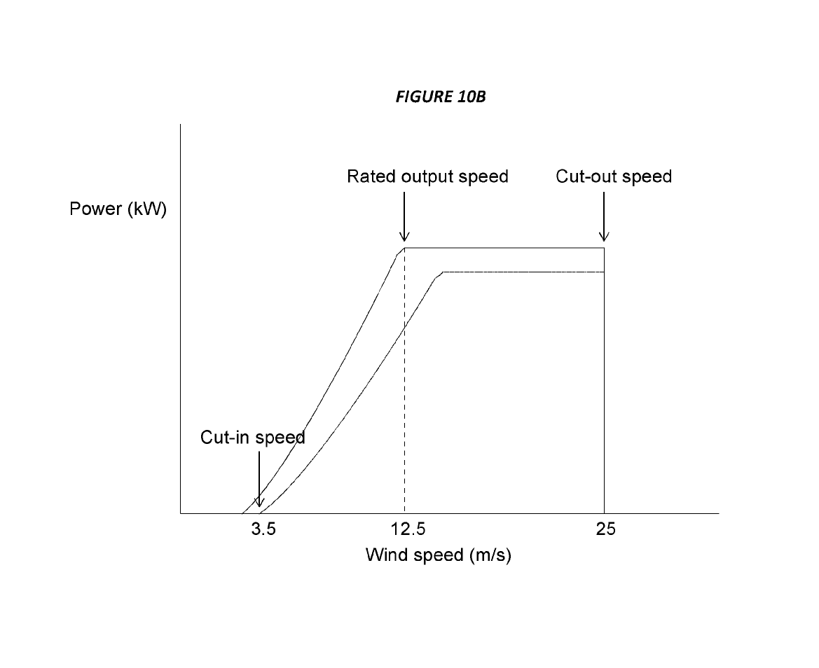

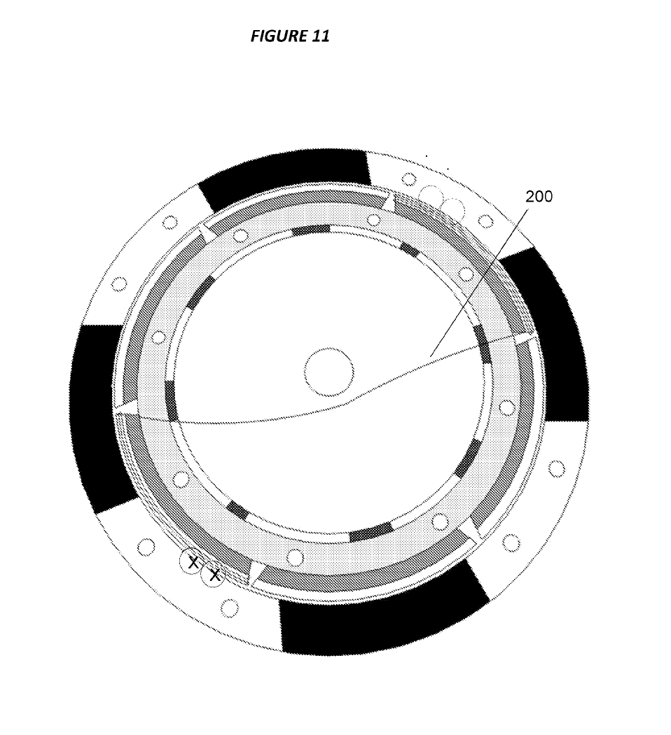

FIG. 11 shows a variant of cross sectional view of one generator unit assembly comprising of the rotor disc ring, stator poles with coils and the electronic control system in the central part of the rotor. The coil windings identified.

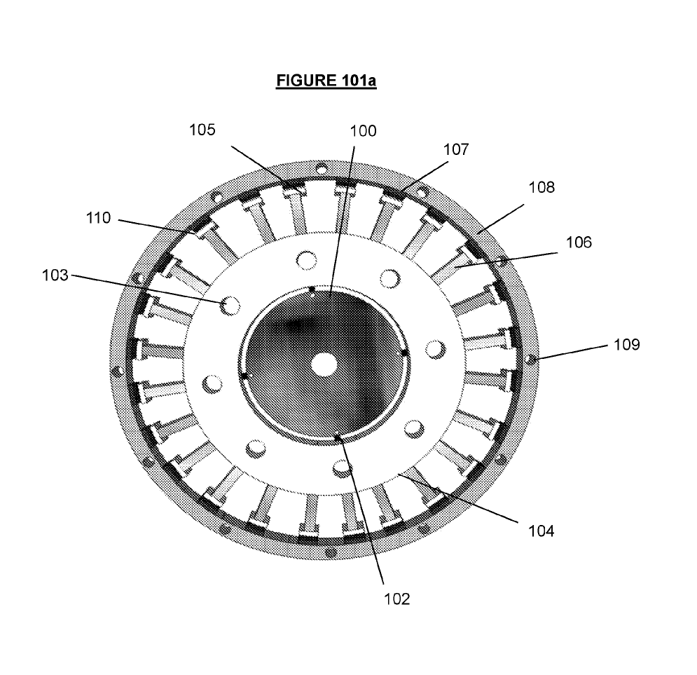

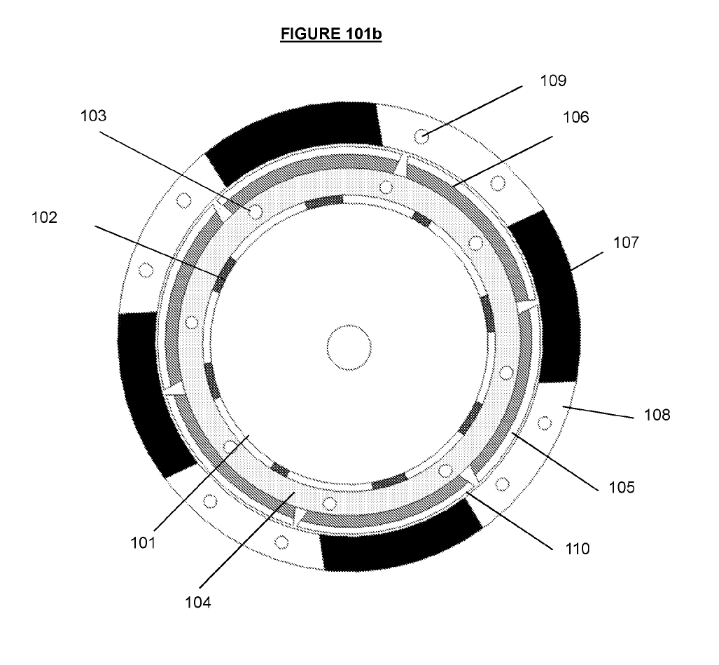

FIGS. 101a and b is two variants of cross sectional view of one motor unit assembly comprising of the rotor disc ring, stator poles with coils and the electronic control system in the central part of the rotor;

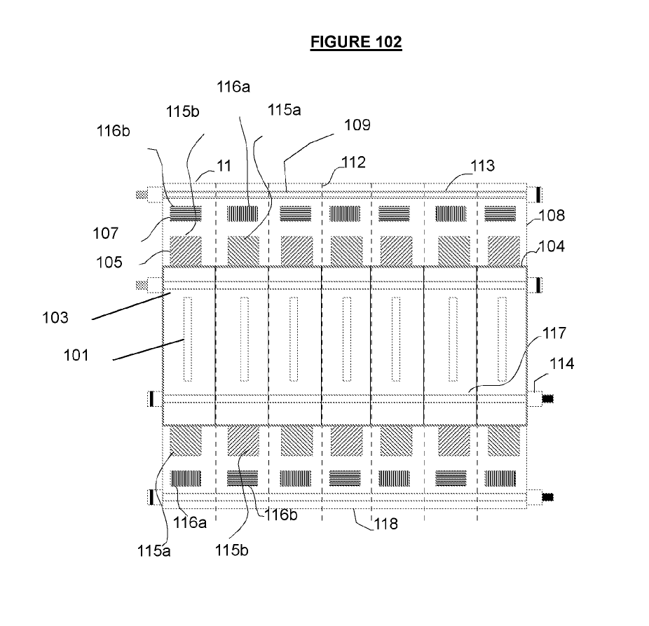

FIG. 102 depicts a cross sectional view of the stacked motor disc assemblies;

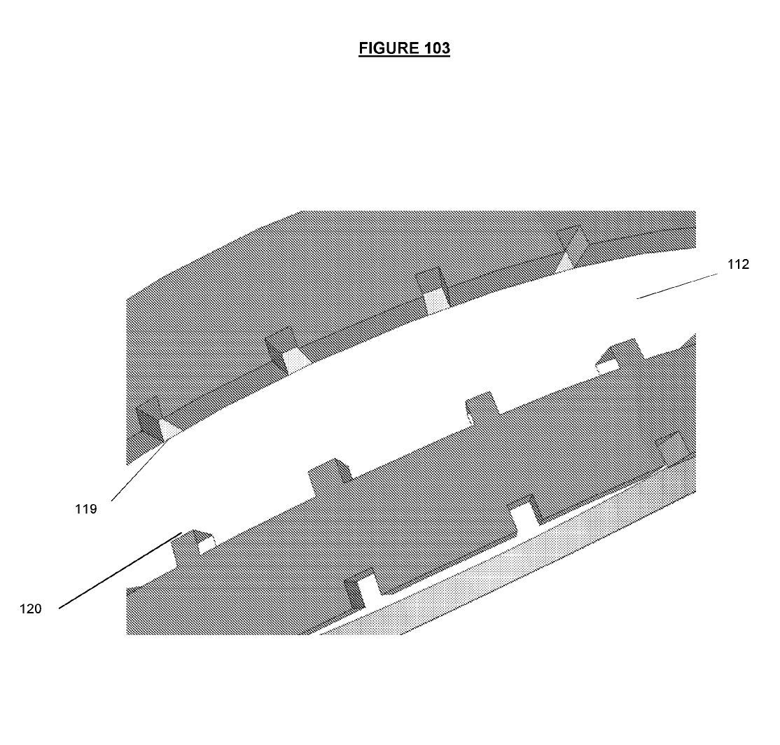

FIG. 103 shows the enlarged view of the fitting joints to affix adjacent rotor disc frames in place.

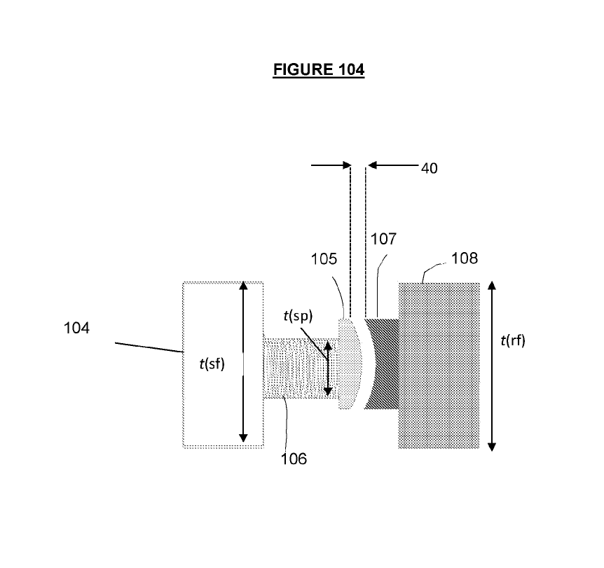

FIG. 104 illustrates a cross section view of the stator frame and armature with windings, and its thickness relative to the paired rotor magnet affixed to the rotor frame.

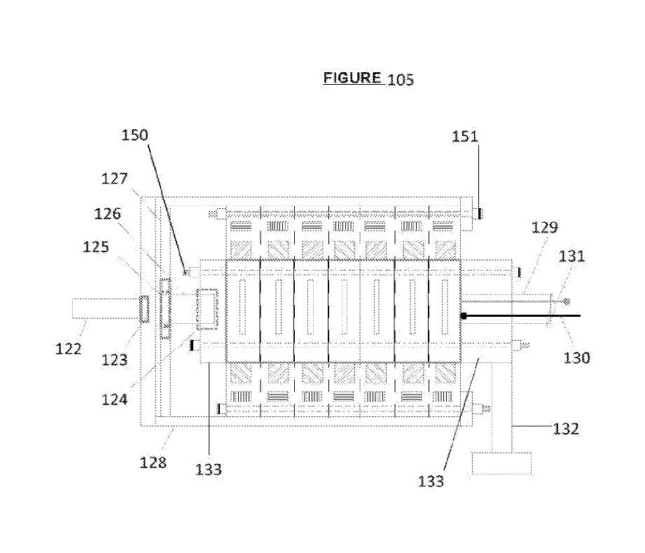

FIG. 105 depicts the possible arrangement of the shaft, bearing, cabling to the motor, stator stand, and rotor solid disc cup.

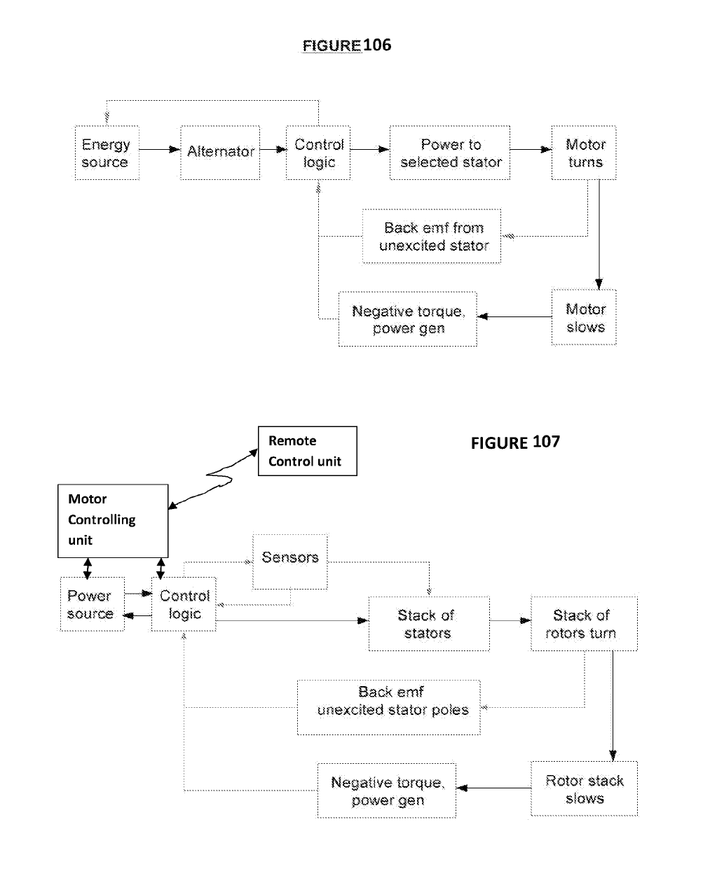

FIG. 106 shows the block schematic of the sequence of the power flow to the motor from the energy source and the power recovered from the motor directed to the energy source.

FIG. 107 shows the block diagram of the operational process of the motor involving control of the power to the stator, feedback and the rotor operation steps.

### DETAILED DESCRIPTION OF THE PREFERRED EMBODIMENT

With reference to the drawings 1-10, an electric generator disc assembly 30 according to the present invention is shown in FIGS. 1A and 1B and a cross sectional views of the same in for example FIG. 101a. The components and construction may in one embodiment be the same as described for the motor assembly described in FIG. 101-107. A rotor ring/frame 1 comprising multiple pairs of magnets 2, where the magnets 2 are arranged inwardly on the inner surface of the rotor ring 1, and the magnets may be of any type of suitable magnets/electromagnets. The rotor ring 1 is arranged outside an armature assembly 3, 31, 104, 106, 105 comprised of a stator frame, outward protruding stator poles and corresponding electrical wire windings on the stator poles, resulting in a magnetic flux being of a polarity defined by the winding direction when a current is applied to the windings. The inward facing magnets of the rotor faces the outward protruding magnets of the stator. The spacing between the adjacent magnets is uniform throughout the entire circumference of the rotor ring 1. The armature coils 3 of the stator 31 are arranged having a uniform suitable air gap 32 from the rotor. The air gap 32 may be customized to account for vibration, starting torque requirements, magnetic field strength and other parameters. Typically the air gap 32 is designed to be as small as possible. Factors that influence the air gap 32 are for example the magnetic field strength and heat dissipation capacity from the coils.

In order for the armature assembly 31 to remain static (at rest) and not affected by the movement of the rotor(s) 30, a circular frame 8 with bearings 6, 7 is provided inside the armature-rotor assembly. According to techniques known in the field the bearing arrangement within the armature necessitates a bearing frame coupled to a rotor 10 which in turn is held together by a shaft 34.

The speed in which the rotor 10 revolves is a function of the speed of a connected turbine shaft 4 and thus the electrical energy generated depends on the speed of turbine rotation. The dimension of the generator assembly is customizable, and for example the width of each rotor 1 frame can have any dimension.

The diameter of the rotor frame 1 and stator disc 31, number of stator windings 3 may be customized to match the turbine speed and power generation capacity of a given case. The magnets 2 in the rotors 1, which are adjacent to each other have alternating north-south polar arrangement and may be in an electromagnet configuration, may be excited by means of an external DC generator which is not shown. Once the generator is in production mode, magnetizing power may be drawn from the generated electrical power in the stator windings 3.

Furthermore the polar arrangement is illustrated in FIG. 2A by vertical lines 35b identifying a north pole and horizontal lines 35a identifying a south pole on the rotor magnets 2. Each magnet 2 is arranged on the inside surface of the rotor frame 1.

The magnets in the rotor may be permanent magnets, and one alternative for fixing such magnets 2 to the rotor frame 1 is to provide the rotor frame 1 with cavities/recess/groove formed in the form of the magnet 2, such that when the magnet 2 is installed into the groove, there is a tight fit. Further fastening means may be used, such as glue, mechanical bonding or other. The recess is further typically lined with a hardened rubberized material for supporting the magnet. A rubber shielding maybe arranged over the magnets 2 to increase lifetime and for minimizing vibration damages of the magnets or the magnet fixation in the grooves. The double arrangement of the magnets in the rubber lined cavities together with the rubber shielding over the magnets' inward facing surfaces ensures a stern fixation to hold the magnets' position during high speed rotational movement of the rotor 1.

Electro magnets, with their core and windings may use similar arrangements ensuring a good and stable attachment to the rotor.

The bolt holes 11 in the stator disc may serve to hold the stack 40 of stator units with armature windings together in place. One embodiment of the invention may comprise having a leading edge of the rotor frame comprising a plurality of recesses 51 for connecting with corresponding protrusions 50 in the trailing edge of the neighboring rotor frame, as illustrated in FIG. 9. The tongue and groove type of joint 52 patterns between adjoining rotor frames is repeated throughout the stack of rotors for improvement of the robustness of the generator assembly, specifically at high operational speeds. Hall effect sensors 53 and/or other types of sensors 53 are arranged at appropriate positions of the generator assembly to determine the starting position of the generator/positioning of the rotor 1. It is further an option to use the sensors 53 for detecting other parameters such as temperature, g-forces (gyro type sensors), magnetic flux, turbine, wind speed and other. The sensors may for different purposes be arranged in positions other than illustrated.

In the figures a number of horizontal holding bars 17 are provided for holding the active rotors of the generator. The holding bars 17, is in a first end attached peripherally to the rotor end disc arranged at equispaced distances, and extends transversally over the rotor discs. The holding bars 17 may be length adjustable as shown in FIGS. 1B, 2B, 4B, 5B, 6B, and 7B, for example by hydraulic/pneumatic features, and their length is set to span the width of entire set of rotor(s) in the active assembly. The holding bars 17 comprise one or more clamps 21 arranged such that it is brought to an extended form 22 and embraces the desired number of rotor(s) once the desired numbers of rotor(s) are positioned in the active generator assembly, and the holding bar spans at least the number of active rotors. The possibility to alter the number of active rotors being comprised in the rotor assembly which revolve with the shaft enables optimal use of the mechanical load for a given turbine speed. To further ensure reliable positioning of the rotors in the active assembly and to hold them in place; Bolts 42, that may be length adjustable, may be arranged and run through the rotor assembly at selected orbital intervals. The bolts 42, is in a first end attached peripherally to the rotor end disc 10 or a solid disc 8 arranged to also comprise a bearing for the end connection to the stator disc assembly. Rotor end disc 10 and solid disc 8 may be integrated in one disc configuration. The bolts 42 may be arranged at equispaced distances, and extends transversally through the rotor discs in prefabricated conduits in the rotor discs. The bolts 42 may be length adjustable to the length of the number of active rotor discs. In the second end of the bolts they may comprise a latch 45 mechanism for locking the rotors of the active rotor stack in place, the latch 45 may be activated by for example a spring/pneumatic system.

Depending on the design of the adjustable bolts, it may be possible to omit the use of the horizontal holding bars.

It is even foreseen that the active and passive rotors are held by holding elements (not shown) arranged on the surface of the stator disc stack assembly, such that horizontal bar 17 and/or bolts 42 may be obsolete.

The magnets in the rotors 1 are arranged in a manner such that opposite poles are adjacent to each other 35a, 35b throughout the entire inner frame of the rotor frame. Generator discs in the stack are arranged in a manner such that a north pole 35b of one disc would be arranged in the location of the south pole 35a of the adjacent disc, and this pattern is repeated throughout the entire generator stack, see FIGS. 2A and 2B. The sequence of the alternate polarity of the rotor magnets and stator poles are repeated through the entire stack.

One of the ends of the rotor frame may be attached to a solid rotor end disc 10 having a shaft 4 centrally fixed protruding outwards away from the generator assembly which is attached to/or being comprised of for example the turbine shaft (not shown). The solid rotor end disc may be formed as a cup 10 to strengthen the frame holding the protruding shaft. A cup design may comprise sidewalls of the cup stretching as far as around the first rotor disc 30 of the rotor disc stack, the first rotor disc being permanently bounded by the rotor end disc, and hence also the shaft 4. In the case more than one rotor disc being configured as permanently bounded to the rotor assembly, the end disc cup may encompass as many as all the permanent rotors. The shaft 4 which revolves along with the turbine is coupled to the rotor via the rotor end disc 10. The end disc 10 may be connected to the stack of rotors by means of controllable clamps 21 supported in a number of holding bar frames 17 running through the entire length of the rotor disc stack width. The controllable clamps 21 can be extendable in order to latch 22 and hold a required number of active rotors in an active rotor disc assembly. The latch extension may be provided by means of control mechanisms using one or a combination of controlled pneumatics/hydraulics, electric motor and/or magnet power.

The torque transferred to the generator by the shaft originates from the revolution of the turbine which in turn governs the rotation of the rotor discs in the generator assembly, and due to the firm coupling of the attached solid rotor end disc 10 at the rotor stack end, all kinetic energy is transferred. The solid rotor end disc 10 may be made of any metal or any other material with sufficient rigidity, for example carbon fiber composite materials.

An insulation material, such as plastic, may be affixed to the surface of the stator disc and arranged to isolate each of the stator pole windings. The ensemble of stators arranged in a stack configuration may be achieved by means of bolts 12 running through the entire stator assembly 40 which may be fastened to a solid stator end disc 15, the end disc 15 may comprise or may be mounted to a suitable solid stand 16 at a first end of the stator assembly, the first end being opposite the generator end comprising the shaft being connected with the rotor end disc 10. A bearing arrangement 6 may be provided at the opposite second end of the stator assembly. To minimize vibrational effects between the bearing arrangement 6 and a small shaft 34 coupled to the solid stator disc frame 36, a vibrational attenuation means 7 may be comprised in the solid stator disc frame to receive one end of the small shaft 34. The bearing arrangement 6 is placed at the opposite end of the stator disc frame 36 of the end which fixed to the solid stand 16. The bearing arrangement 6 is connected to the rotor shield cup 10 further by means of a solid disc 8. The solid stator end disc at the end of the solid stand may comprise a conduit or hollow tubular arrangement 13 carrying suitable cables 14 for transferring power and control signals between the generator and external equipment and power grid/storage. The stator stack attached to the bearing arrangement 6 is held stationary while the outer ring, which is fitted with the solid rotor disc, revolves along with the movement of the rotor frames.

FIGS. 4 A and B shows a three dimensional illustration of the generator assembly. The rotors which are at rest may be held on individual height adjustable cart 18 and trolley 19. When a rotor 1 is brought in contact with the active rotor assembly, the horizontal bars 17 and clamps 21, 22 are positioned, and the corresponding cart is lowered as far as to avoid impeding the rotation of the rotors. The carts vertical movement may be facilitated by hydraulic and/or pneumatic arrangements and support means 41 to raise/lower as required.

The sequence of adding more number of rotor discs to the generator assembly is illustrated in FIGS. 2, 4, 5, 6 and 7 wherein the rotor disc 1 held on cart 18, the cart 18 may be supported by wheels 19 and adjustable frames 40. For adding more rotor discs, the generator revolving motion is stopped before the cart are moved in position for shifting the required numbers of rotors, and the corresponding clamps are set to its extended form 23 and the conveyor belt 20 moves in the direction 25 towards the active rotor(s). When the new rotor discs reach their position within the active rotor stack, the controllable clamps 21 in the holding bar is adjusted to its extended form 22 to clamp the entire rotor disc assembly, and the cart clamps are retracted 26. After the controllable clamps are positioned the hydraulic/pneumatic adjustable frames 40 in the carts are lowered to leave the rotor to be supported by the adjacent rotors assembly. The sequence of removing the rotor disc is illustrated in FIG. 7, in this case the hydraulic/pneumatic adjustable frames 40 in the carts of the rotor is first extended to the rotor after which the cart clamp in its extended form 23 locks onto the rotor followed by the retraction of the controllable clamps 21 which is then subsequently followed by the movement of the conveyor in the direction away from the fixed 28 rotor. Under all conditions of addition or removal of the rotor discs in the generator assembly the actions are set to be performed seamlessly and reliably with less downtime. These functions may be coordinated and controlled by means of a master controller and the sequence of which is outlined in FIG. 8.

The elements in FIG. 8 comprise the Controller, an automatic voltage regulator, AVR, and an Exciter for driving the electromagnets of the Rotor stack. It should be noted that in the case where permanent magnets are utilized in the rotor, the Exciter may be omitted. The Rotor stack and the load and Position sensors are together with the Conveyor module controlled by the Controller. The system feed information from other sensors to the Controller, such as Speed sensors. Other sensors types may be used to optimize operation relative to the energy input availability and environmental conditions. The system may further be provided with a Power storage, for powering electromagnets in Rotor, Conveyer belt, sensor power and other. The Power storage may be charged by power generated by the generator, or with power from the grid.

According to the present invention, where the stator assembly does not have a rotor axle penetrating through the center of the stator, a space is freed up which may house an electronic control system enabling an improved measure of control. The embodiments described here makes use of the one separate smaller bearing arrangement 6 at one the end of the stack and a suitable shaft extending outwards to the turbine delivering the rotational movement. The removal of the inset bearing and shaft within the stator stack further reduces the overall weight of the generator which enhances the torque-speed characteristics. The omission of the bearing arrangement within the stator disc also mitigates acoustic noise and facilitates more easy access to replace/change the bearing after potential wear. Moreover, the exclusion of bearing arrangements within the stator decrease the overall weight of the collective bearing arrangement, which reduces the resistance due the mechanical friction in the bearings, which further has direct impact on performance resulting in improved torque and reduced thermal heat losses. To reduce thermal heat losses, a sufficient air gap 30 between stator coils and rotor magnets is defined. The cylindrical form of the rotor frame stack encasement ensures minimal expense of aerodynamic loss and alleviates potential dust intrusion during the rotation of the rotors.

In the case when a portion of the power is stored a charge storage unit such as a capacitor bank/battery may serve as an intermediate energy storage unit prior to the transfer of power to the grid.

Another pertinent feature is the stack configuration improves the torque-energy balance and improves the generator scalability as per the speed of the turbine. The present invention may improve energy generation rate by 15-25% or more.

The distribution of the energy to magnetic flux among the attached rotors in the generator assembly also reduces the thermal losses in the armature coils. Another implication of this configuration is the lower need of mechanical torsional force of the rotor assembly to produce the same magnitude of electrical power the as in a single large generator unit with similar dimensions of width and cross sectional diameter. The generator assembly according to the invention will reduce dimension and weight parameters with 10% or more, with corresponding performance gain in power to weight ratio.

FIGS. 10 A and B shows the power generation as a function of wind speed. FIG. 10 A sows a traditional gear driven turbine, whilst FIG. 10 B show an electrical generator according to the invention (solid line in graph) showing the advantage over conventional gear box coupled (discontinuous line) wind turbine wherein the efficiency of power generation is higher and can reach over 50% at certain wind speeds.

The magnetic field of the rotating rotor with respect to the static coil windings in the stator facilitates the flexible generation of power, matching the turbine rotation speed without the use of additional gears and gear boxes.

This electrical generator assembly of the present invention may comprise a generator controlling unit which communicates with, and controls, the control logic which may be arranged externally, and which may determine the number of rotors needed as the speed of the turbine varies.

The control units housed in the generator disc may be controlled, and monitored by a suitable computer, the computer being optionally located at a remote location, communicating via a communication system. A communication system may be a wireless or sired communication system or a combination thereof.

In a further embodiment of the invention, the number of connected rotor frames are matching the number of stator discs at a permanent basis. The rotors electromagnets and/or stator winding may dynamically be switched to play an active part or not of the power generating elements. This may result in that one or more rotor and will not have their magnets energized, or the windings in the corresponding stator assembly is deactivated (e.g. by short circuiting the windings), and hence thre will not be created a magnetic field that will create a power generation in the corresponding stator windings. It is further an option to use the controlling units to energize only a number of the magnet pairs of the rotor in any individual rotor assembly, an in that way for example energize only half of the magnets in each rotor. Thus, halving the magnetic fields able to energize the windings in the stator disc assemblies.

The generator discs may be operated in one or a plurality phase mode for stator excitation where the numbers of stator coils must be either an even number of stator poles in the case of one phase, or any even multiple of number of phases where two or more phases are chosen, for example must a 3 phase mode may have 6 or 12 . . . active stator poles. Typically, each phase have at least two stator coils (a pair). For example such that a 3 phase mode have 6 stator poles as shown in an example in FIG. 12 wherein one of the stator pair windings 200 is shown. A control system arranged in the stator disc may be used to monitor and control the winding status of the stator. The control system may comprise both hardware based logic, microcontrollers and other computing means able to store and execute program code for optimal performance of the generator assembly. It can in one example be that there are 12 stator poles representing 3 phases, ie, 2 pairs of stator poles for each phase. Then when driving force is low, for example, low wind driving a connected wind turbine, one pair set of phases are open circuited, so that they do not represent a load. The turbine may then drive the generator at lower speed than if all stator pole pairs where active. It is envisaged that a control system connected to each individual stator controller may ultimately control all the stator pole windings and being able to format the load of the generator in a very flexible manner. For example if a stator winding is detected as faulty, the load can be controlled in relevant other stator pole windings to maintain stability of the generator. It is even within the scope of the invention, in the event that the rotor magnets are of an electromagnet type, to control the magnetization of the rotor magnets in a similar manner, for achieving similar functionality.

The controller may also be used to disable/enable one or more complete stator-rotor disc assemblies being part of an assembly, under active operation. This being specifically valuable in a configuration where all rotor discs are combined together to be a part of the active assembly quasi permanently, but also in setting where driving forces are often shifting, and stopping the generator each time to change number of active rotor rings which otherwise will cause too much overhead/at rest time.

It is also envisaged that the invention will comprise an automated operation and adaption to available turbine forces, such as varying wind speed for a wind mill turbine. It is in such an environment provided a control system that is able to receive forecasts for a planned turbine speed, such as increased wind speed in the case of wind mill turbine, and then in advance, before the wind speed actually have increased, prepare a suitable number of rotor discs being added to the active rotor disc assembly of the electrical generator.

The present invention is innovative in several aspects, and the advantages are exemplified by the following aspects.

The generator discs assembly according to the present invention has a much lower noise generation during operation owing to elimination of gear box system compared to comparable prior art.

The generator according to the present invention allows seamless scalability of the rotors discs in the generator assembly in stacked configuration respective to the turbine speed.

The stacked generator disc arrangement can provide for physically smaller dimensions than a similar power single cylindrical generator unit, required to run at a similar speed for a given capacity, due to the effective distribution of mechanical power among the rotor stacks thus facilitating power generation at a wide range of turbine speeds.

Additionally, at any given instant of generator operation only the magnitude of electrical power which can be generated relative to the turbine speed is obtained by selectively adding or removing rotor discs to the whole generator assembly. This feature is particularly significant at low turbine speeds and allows for generation of power without the need to stall the turbine for long intervals.

The electrical power generated depending on the torque of the turbine in a more controlled fashion without overheating the armature coils 3 due to effective distribution of the mechanical rotor load in the generator assembly.

The lower heat dissipated from the coils ensures reduced mechanical wear and tear. More importantly the lifetime of the generator is prolonged and potential need for expensive part replacements may be reduced or avoided.

The advantages of scalability of this generator design can be used to readily serve to generate power ranging from very low to high turbine speeds without the addition of extra moving parts in the form of gears. The elimination of gear wheels in addition to saving weight, saves space and additional maintenance costs.

The different aspects and configurations of the possible embodiments and the advantages of which thereof are apparent in the following claims. Furthermore, owing to the changes which might be realized as per this embodiment by those skilled in the art, the scope of this invention is not limited to the exact configuration and the operation described here. Therefore any such modifications, equivalents and variants of this invention might be taken to fall under the scope of the invention according to the following claims.

Some advantageous features of the invention can be:
The design of the electric generator disc according to the invention may allow for stacking of additional rotor discs of similar diameter matching the speed/torque characteristics of the turbine.
The design of the electric generator according to the invention may generate power at very low turbine speeds.
The design of an electric generator according to the invention may be highly scalable and produces higher operational range of turbine speeds.
The design of the generator according to the invention may allow for controlled power generation among the stacks of the rotor-armature pair active in the assembly at a given time.
The design of an electric generator according to the invention may be highly responsive to the turbine speeds for spinning the rotors in the generator at a certain speed due to the continual power control monitoring via an electronic control system.
The design of an electric generator according to the invention may dissipate much lower levels of thermal heat and reduced mechanical wear.
The design of an electric generator according to the invention may give rise to reduced acoustic noise levels during the operation due to the lower mechanical friction.
The design of the electric generator according to the invention may improve the lifetime of the electric generator without performance degradation.
The design of the electric generator according to the invention may prevent the armature coils from sudden surge in power by means of controlled rate of addition or removal of the rotor disc in the active generator assembly via an electronic control system.
The design of the electric generator according to the invention may enable the controlled and steady rate of power generation optimal to a given turbine speed and can transfer the energy to the grid and charge storage unit.
The design of the electric generator according to the invention may produce higher energy at lower turbine speeds without the need of additional gear systems.
The design of the electric generator according to the invention may be readily scaled for the overall speed of the turbine, such that the highest amount of electrical power can be generated with minimal downtime.
The design of the electric generator according to the invention may require no shaft running through the entire central axis of the generator disc.
The design of the electric generator according to the invention may have separate set of cables for drawing and feeding back power from and to an energy storage/supply source respectively.
The design of the electric generator according to the invention may produce lower vibration during the generator operation due to the external placement of the rotor frames and rigid placement of the stators in the stack arrangement.
The design of the electric generator according to the invention may have the rotor magnets energized by means of a small DC exciter which is controlled by an automatic voltage regulator.
The design of the electric generator according to the invention may restrict the maximum current limit which can be drawn by the stator to a preset value, controllable by the electronic control system, ensuring the safety of the stator coils.
The design of the electric generator according to the invention may occupy reduced space due to the direct power transfer from the turbine to the generator, requiring no intermediate gear wheels.

A first embodiment of the present invention is further defined to comprise an electric generator comprising:

a driving shaft for receiving power from an external power source by being rotated, one or more generator disc assemblies, the generator disc assembly comprising a central part of one or more stator assemblies (3, 40) having outward protruding coil windings (3), wherein the number of coil windings are a multiple of (2), the generator disc assembly further comprising one or more rotor ring frame assemblies (1) arranged peripherally around the stator disc assembly (3,40), wherein the rotor ring frame assembly (1) further comprise a set of magnets (2) being arranged on the inside surface of the rotor ring (1) directed inwardly towards the stator disc assembly (3,40), wherein the magnets are arranged such that adjacent magnets have an alternative north-south polarity.

A second embodiment of the invention comprise an electric generator according to the first embodiment, wherein the coil windings that are arranged in pairs being arranged opposite each other on the stator disc protruding outwards have opposite polarization.

A third embodiment of the invention comprise an electric generator according to the first or second embodiment, wherein a plurality of generator disc assemblies are arranged together in a generator disc stack where the stator disc assemblies (3,40) are connected in a fixed arrangement.

A fourth embodiment of the invention comprise an electric generator according to any of the previous embodiments, wherein the number of rotor ring assemblies (1,2) which are active are adapted to the available power and speed input via the driving shaft.

A fifth embodiment of the invention comprise an electric generator according to any of the previous embodiments, wherein the number of rotor ring assemblies comprise one or more non-active rotor ring assemblies (1,2).

A sixth embodiment of the invention comprise an electric generator according to the fifth embodiments, wherein a non-active rotor ring assembly is defined by being fixedly bound to a first rotor ring by physical means such that it rotates with all the active rotor ring assemblies, but wherein the magnets are non-magnetized electro magnets.

A seventh embodiment of the invention comprise an electric generator according to the fifth embodiments, wherein a non-active rotor ring assembly is defined by being physically detached from the revolving rotors such that when the active rotor assemblies revolve with the rotating shaft, the non-active rotor assemblies are kept static at rest.

An eight embodiment of the invention comprise an electric generator according to the seventh embodiments, wherein magnets in the rotor assemblies are electro magnets.

A ninth embodiment of the invention comprise an electric generator according to the seventh embodiments, wherein magnets in the rotor assemblies are permanent magnets.

A tenth embodiment of the invention comprise an electric generator according to any of the previous embodiments, wherein the edges of the rotor ring frames (1) are formed with recesses (51) and protrusions (50) for engaging in a locked manner with the neighbor ring frame (1).

An eleventh embodiment of the invention comprise an electric generator according to any of the previous embodiments, wherein the stator disc (40) has predrilled holes (11) for receiving bolts (12) to connect the stator disc assemblies (3,40) in a locked manner.

A twelfth embodiment of the invention comprise an electric generator according to any of the previous embodiments, wherein the stator disc (40) comprises one or more set of coil windings (3), each set corresponding to a unique phase of power generation, and the rotor ring frame (1) comprises of a number of electromagnets (2) facing the stator coils (3) where each adjacent magnet is arranged with opposite poles (35a, 35b) directed inwards.

A thirteenth embodiment of the invention comprises an electric generator according to any of the previous embodiments, wherein the rotor magnetic cores are symmetrically arranged throughout the circumference of the stator disc and rotor ring frame.

A fourteenth embodiment of the invention comprise an electric generator according to any of the previous embodiments, wherein the electric generator further comprises an recover energy storage in addition to the supply cables to the grid for storing a small fraction of generated power.

A fifteenth embodiment of the invention comprises an electric generator according to any of the previous embodiments, wherein the addition/removal of rotor discs to the fixed rotor assembly is relative to the increase/decrease in the speed of the turbine.

A sixteenth embodiment of the invention comprise an electric generator according to any of the previous embodiments, wherein the rotor disc stack is in one end connected to a solid end disc, the end disc (10) having means for transferring the rotational forces from the turbine to rotors of the electric generator.

A seventeenth embodiment of the invention comprise an electric generator according to any of the previous embodiments, wherein the solid end disc (10) is made of a rigid material, such as metal or carbon fiber composite materials.

An eighteenth embodiment of the invention comprise an electric generator according to any of the previous embodiments, wherein the end disc (10) is joined with holding bars having weighted clamps to hold two or more rotor ring frames (1).

A nineteenth embodiment of the invention comprise an electric generator according to any of the previous embodiments, wherein a rotor shaft (4) is arranged centrally and protruding from the end disc (10), outwardly away from the rotor stack.

A twentieth embodiment of the invention comprise an electric generator according to any of the previous embodiments, wherein the stator disc stack is in one or both ends connected to a stator end disc (36).

A twenty-first embodiment of the invention comprise an electric generator according to any of the previous embodiments, wherein the stator end disc (36) is made of a rigid material, such as metal or carbon fiber composite materials.

A twenty-second embodiment of the invention comprise an electric generator according to any of the previous embodiments, wherein the stator end disc (36)) in the end pointing towards the rotor end disc, comprising a vibrational attenuation means (7) and a shaft (34) coupling the stator end disc (36) to a bearing arrangement 4 comprised in the rotor shield cup (10).

A twenty-third embodiment of the invention comprise an electric generator according to any of the previous embodiments, wherein the stator end disc (15) in the end pointing away from the rotor end disc, comprising a solid stand (16) for mounting the electric generator and keeping the stator disc stack stationary under operation.

A twenty-fourth embodiment of the invention comprise an electric generator according to any of the previous embodiments, wherein the stator disc assemblies (40) are fixedly connected by bolts (12) running through prefabricated holes 11 in the stator discs.

A first method embodiment for operating an electrical generator as defined in any of the previous embodiments of the invention comprising an electric generator is defined by the method comprising the following steps:
provide the generator controlling unit with instructions for running the electrical generator,
the generator controlling unit communicating with each control unit (1) in the stator disc array, where each control unit (1) controls the operation of the individual stator coils (6) of respective stator disc (4) as instructed,
retrieve power through all stator windings (6) when torque is applied to the rotors, and storing it at an energy storage,
provide necessary power supply to the electrical generator from either an energy storage or from the power generating stator windings.

A first system embodiment for operating an electrical generator as defined in any of the previous embodiments of the invention comprising an electric generator is defined by the system comprising a generator controlling unit, a host for controlling the electrical generator assembly, and connecting device connecting the electrical generator assembly to an energy storage or electrical grid system. A second system embodiment for operating an electrical generator as defined by the first system embodiment, wherein the host is a wind turbine.

A third system embodiment for operating an electrical generator as defined by the first or second system embodiment, wherein the generator controlling unit is connected to a weather forecast resource in order for adapting the generator assembly characteristics in accordance with forecasted wind speeds.

The content of the priority application is summarized in the following pages of this description and is regarded as part of the present application:

The primary focus of the priority application is of a scalable electric motor disc stack with multipole stators.

The priority invention relates to electric motor disc stacks, and more specifically to any type of applications requiring electric motors.

The electric motor disc comprises of a stationary stator element with multiple poles protruding from the circumferential edge of the stator disc. The rotor, being the rotating element is fitted with strong permanent magnets which are aligned to the stator poles. The arrangement of the magnets in the rotor is alternated with north and south poles respectively throughout the entire circumference of the rotor ring. The poles in the stator are wrapped with windings and the energy is fed to each respective pole windings from a suitable power source. Upon application of an electric field to the stator pole windings the rotor is caused to spin.

In order for the stator unit to remain static (at rest) and not affected by the movement of the rotor, a circular frame with bearings is provided inside each stator-rotor assembly. According to techniques known in the field the bearing arrangement within the stator necessitates a bearing frame coupled to a rotor which in turn is held together by a shaft.

Typically motor discs are fitted with a shaft running through the entirety of the central part of the stator-rotor assembly. It is a problem with current techniques that the space within a stator disc is very limited due to shafts occupies much of the central space.

It is further a common approach in the industry to custom design each stator-rotor design according to the power and speed requirements of the application. It is thus a problem for the industry that in many applications the stator-rotor parameters are not optimal for the application, for the fact that it may be cheaper/quicker for the vendor to supply the application with an off the shelf stator-rotor design, not specifically designed for the application.

The priority invention provides for a stator-rotor assembly without a centrally arranged shaft and shaft bearings through the motor cross sectional length, enabling a printed circuit board comprising a control system to be embedded within each stator disc, and the space occupied normally by a shaft and the bearing frame within the stator-rotor assembly is occupied by the printed circuit board. The control system provides precise control over the desired torque for the individual corresponding stator-rotor assembly, motor disc assembly. The printed circuit board may comprise all the required electronic components for managing the power distribution to the stator pole windings.

It is further an aim for the priority invention to provide a motor assembly comprising a plurality of motor disc assemblies, each comprising a stator, a rotor and a control system where the energy needed for providing the power requirements to the motor may be distributed and shared among the plurality of individual motor discs uniformly. The number of the poles in the stator is determined according to the power output requirement of the individual motor disc assembly. One complete assembly of the electric motor can include ‘n’ number of motor disc assemblies in a disc stack matching the mechanical rotational force needed to drive a required load for the application.

It is further an aim to provide a flexible power consumption profile by selective use the poles of each stator, and also to use the remaining poles for generating energy. The generated energy maybe channeled to an energy storage/supply source.

The torsional moment generated by the rotor is harnessed into an external shaft which may be fitted at the center of the periphery of one end of the disc stacks. One embodiment can contain multiple stator-rotor discs, motor disc assemblies, stacked together and where each motor disc assembly is in alignment with the neighboring sides motor disc assemblies. The ensemble of the stacked motor disc assemblies may be held together by means of bolts running through prefabricated holes in the stator disc 150 and rotor rings 151 at appropriate intervals. At each peripheral end of the disc stack an end plate may be attached. The end plate may be of the same circular configuration as the side relief of the disc stack, and may further comprise foundation for a centrally fixed, or integrally mounted, and outwardly protruding shaft. The shaft may serve as a bearing for the motor disc stack as well as for output of the torsional force of the rotor part of the disc stack when rotating due to the magnetic force induced in the stator discs.

With reference to the FIGS. 101-107, an electric motor disc assembly 101 according to the priority invention is shown in FIGS. 101a and 101b comprising an electronic control system disc 101 arranged in central part of a stator (104). A rotary ring 118 comprising multiple pairs of permanent magnets 107 inwardly arranged on the rotary ring 108 may be of any type of suitable permanent or electromagnets. The spacing between adjacent magnets is uniform throughout the entire circumference of the rotor ring 108. Multiple poles 105 protrude from the outward facing circumference of the stator disc frame 104. Each pole 105 is arranged to align with the inwardly pointing surface of a respective magnet 107 comprised in the rotor frame 108 such that each pole 105 is coupled geometrically with one permanent magnet/electromagnet 107. The width of the stator disc frame 104 is greater than the stator pole 105 width, thereby allowing space for coil windings 106 around the poles 105 of the stator 104. Furthermore, the width of the rotor frame 108 matches that of the stator frame 104. The width of the magnets in the rotor 107 is set to match the dimensions of the stator pole heads 105 only separated by an air gap 140. The air gap 140 being custom fitted to account for vibration, starting torque requirements, magnetic field strength and other parameters. Typically the air gap 140 is kept to the minimum possible. It normally depends on the magnetic field strength and heat dissipation capacity from the coils.

The energy required to operate the motor can be channeled from any energy source through the electronic control logic system 101 which feeds the power to the winding 106 of the stator poles 105. Bolt holes 109 which may be arranged in the rotor ring frame enable a stack to be arranged and firmly attached to further rotors. The width of each rotor frame 108 can have any dimension on the condition that it should be consistent to all the rotor frames 108 in the motor stack.

The diameter of the rotor frame 108 and stator disc 104, number of stator pole 105 pairs and windings 6 may be customized to match the speed and torque requirements of a given application. The permanent magnets/electromagnets 107 in the rotors 108 which are adjacent to each other have an alternative north-south polar arrangement. In FIG. 102 this is visualized by vertical lines 116a identifying a north pole and horizontal lines 116b identifying a south pole on the permanent magnets 107. Each magnet 107 is affixed to the inside surface of the rotor frame 108. One alternative for fixing the magnets 107 to the rotor frame 108 is to provide the rotor frame 108 with cavities/recess/groove formed in the form of the magnet 107, such that when the magnet 107 is installed into the groove, there is a tight fit. Further fastening means may be used, such as glue, mechanical bonding or other. The recess is further typically lined with a hardened rubberized material for supporting the magnet. A rubber shielding maybe arranged over the magnets 107 to increase lifetime and for minimizing vibration damages of the magnets or the magnet fixation in the grooves. The double arrangement of the magnets in the rubber lined cavities together with the rubber shielding over the magnets' inward facing surfaces ensures a stern fixation to hold the magnets' position during high speed rotational movement of the rotor 108. The bolt holes in the stator disc 103 may serve to hold the stack 117 of stator units together in place while keeping the alignment with its respective rotor intact. In one embodiment of the priority invention may comprise to have the leading edge of the rotor frame comprise a plurality of recesses 119 for connecting with corresponding protrusions 120 in the trailing edge of the neighboring rotor frame, as illustrated in FIG. 103. The tongue and groove type of joint 112 patterns between adjoining rotor frames 119, 120 is repeated throughout the stack for improvement of the robustness of the motor assembly, specifically at high operational speeds. Hall effect or optical sensors 121 are placed between appropriate stator coils to determine the starting position of the motor/positioning of the rotor 108 with respect to the stator poles 106. It is further an option to use the sensors 121 for detecting other parameters such as temperature, g-forces (gyro type sensors), magnetic flux, speed and other. The sensors may for different purposes be arranged in positions other than illustrated for the hall effect and optical sensors 121 in FIGS. 11a and 11b.

The magnets 107 in the rotor are arranged in a manner such that opposite poles are adjacent to each other 116a, 116b throughout the entire inner frame of the rotor frame. Motor discs in the stack are arranged in a manner such that the north pole 16a of one disc would face the south pole 116b of the adjacent disc, and this pattern is repeated throughout the entire motor stack. A corresponding polarity is applied to the respective stator pole to repel its aligned rotor magnet. So if the rotor magnet of one stack is north 16a the corresponding stator pole would be excited to be of positive polarity 115a and at the direct opposite end of the rotor the magnet having the south pole 116b would be paired with a stator pole being of negative polarity 115b. However the stator pole in the adjacent disc in the same position would have positive polarity 115a paired with a rotor magnet with north pole 16a while the opposite end of this exact motor disc will have rotor south pole 16b paired with a stator negative polarity 115b. The sequence of the alternate polarity of the rotor magnets and stator poles are repeated through the entire stack.

In FIG. 104 it is shown that the thickness of the stator frame t(sf) and rotor t(rf) have a comparable value, and the thickness of the stator pole t(sp) and rotor magnet t(rm) having dimensions lesser than the thickness of t(sf) and t(rf).

i.e., t(sf)=t(rf)>t(sp),t(rm)

One of the ends of the rotor frame may be attached to a solid rotor end disc having a shaft 122 centrally fixed protruding outwards away from the motor assembly. The solid rotor end disc may be formed as a cup 128 to strengthen the frame holding the protruding shaft. For any applications requiring a shaft to drive a load, a rotor shaft 122 maybe shrink fitted 123 to the rotor shield cup 128 to ensure reliable and firm coupling. The cup 128 may be fastened to the stack of rotors buy means of bolts 151 running through the entire rotor assembly and the cup 128. The torque transferred to and by the shaft is originated and governed by the rotation of the rotor discs in the motor assembly, and due to the firm coupling of the attached solid rotor end disc 128 at the rotor stack ends. The solid rotor end disc 128 may be made of any metal or any other material with sufficient rigidity, for example carbon fiber composite materials. An insulation material, such as plastic, may be affixed to the surface of the stator disc to isolate each of the windings in the stator pole. The ensemble of stators arrangement as a stack may be achieved by means of bolts 150 running through the entire stator assembly and may be fastened to a solid stator end disc, the end disc either comprising or being mounted to a suitable solid stand 132 at one end of the stator assembly, and a bearing arrangement 125 at the opposite end. To minimize vibrational effects between the bearing arrangement 125 and the small shaft 126 coupled to the solid stator disc frame 133, a vibrational attenuation means 124 may be comprised in the solid stator disc frame to receive one end of the small shaft 126. The bearing arrangement 125 is placed at the opposite end of the stator disc frame 133 of the solid stand 132 and is attached at the end of the rotor shield cup 128 by means of a solid disc 127, alternatively made of a suitable high strength metal. The solid stator end disc at the end of the solid stand can house a hollow tubular arrangement 129 carrying suitable cables 130 to feed power and control signals to the motor and lead recovered/generated power by means of a separate cables 131. The recovery lines 131 may also comprise signal lines from sensors and control logic inside the stator discs. The stator stack attached to the bearing arrangement 125 is held stationary while the outer ring, which is fitted with the solid rotor shield cup and disc, revolves along with the movement of the rotor frames. In the case an application houses the motor directly in the revolving component such as a spinning wheel; a shaft protruding from the solid rotor disc maybe omitted.

The electronic control system which is arranged in the center of each of the stator assemblies may be fastened to the stator frame 104 by the means of optional plurality of flanges 102 protruding inwardly from the stator frame 104 by means of for example screws and nuts. Other arrangements for attaching the electronic control system will be chosen as appropriate for the application. Fast click, glue, screw windings may be alternatives.

In conventional motors the shaft runs through the entire central part of either the stator which is held on a bearing arrangement to which the rotor is coupled or directly through a rotor. According to the priority invention with the removal of the bearing arrangement within the stator disc frees up the space which is used to house an electronic control system. To achieve the better control of the motor torque one electronic control logic system may be arranged in each and every motor disc unit in the stack. The embodiments described here makes use of the one separate smaller bearing arrangement 125 at one the end of the stack and a suitable shaft extending outwards for any application requiring a shaft to deliver rotational movement. The removal of the inset bearing and shaft within the stator stack further reduces the overall weight of the motor which enhances the torque-speed characteristics. The omission of the bearing arrangement from within the stator disc also mitigates acoustic noise and facilitates more easy access to replace/change the bearing after potential wear. Moreover, the exclusion of bearing arrangements within the stator decrease the overall weight of the collective bearing arrangement, and reduces the resistance due the mechanical friction in the bearings, which further has direct implications resulting in improved torque and reduced heat loss levels.

To reduce thermal heat losses, a sufficient air gap 40 between stator poles and rotor magnets is defined. A fan may be arranged on the shaft to produce an air flow blowing into the motor assembly for cooling the motor. The solid rotor end disc may further be designed with perforations/througholes and vents to facilitate air flow through the motor stacks. The cylindrical form of the rotor frame stack encasement ensures minimal expense of aerodynamic loss and alleviates potential dust intrusion during the rotation of the rotors.

The theory and operation of electronically switched excitation of the stator coils is well known in the art and thus no attempt is made in this disclosure to describe the electrical circuitry required to drive and control the motor presented in this invention.

The embedded electronic control system in each of the stator disc, consumes the required power by distributing current to a number of selected stator poles coil windings. The remaining unused poles and respective coil windings may be configured to generate power by any amount of back emf (electromagnetic flux), the generated power is then fed back to any suitable energy storage/supply source. In the case when the power is stored in a battery a capacitor bank may serve as an intermediate energy storage unit prior to the transfer of power to the battery. In one embodiment of the priority invention the total power needed to produce the required torque by running the ensemble of motors in the stack is determined instantaneously in real time by the electronic control logic system, which in turn may distribute the power equally among all individual stator disc. It is also possible to distribute power in other configurations, for example every other stator disc, every third stator disc, and even a differential distribution between the poles in each individual stator. It should however be a balanced distribution of the active stators and poles in order to enhance stability and minimize vibration losses.

The total power in play at any given instant during the operation of the motor and the power generated from any braking effect and back EMF is expressed in the simplest form by the following equation (1). This equation takes into account the power drained from an energy source required to energize the stator poles and thereby produce the necessary torque to turn the rotor along with power generated from the interaction of magnetic flux between the rotor magnets and non-polarized stator poles.

Ptot=(Pdis−Pin)+(Pout−Prcg) (1)

Where P_{dis} is the discharge of the power from the energy source, and is a function of the energy required for powering the stator Pᵢₙ at any instant. Pₒᵤₜ is a power which is generated by the motor and is a function of the recharge power P_{rcg} along with inherent electrical resistance losses.

Another pertinent feature according to this embodiment is that the entirety of the motor discs in the stack put together acts as a parallel resistive load, and thereby reducing the power needed to generate the required amount of torque to operate the motor at a given speed. The stack configuration improves the torque-energy balance wherein reducing the energy discharge rate from an energy storage/supply source. The priority invention may improve energy savings by reducing the energy discharge rate 15-25% or more.

Having an electronic control system 101 coupled to each of the stator 104 in the motor disc of the stack improves the overall control, torque response, speed management and reliability.

The stator coils 106 which are powered by the electronic control circuit 101 can have variable resistors, which can change the amount of current fed into the stator coils 106 and thereby vary the speed and torque characteristics. The higher the resistance in the stator coils implies a greater starting torque and lower starting current.

The distribution of the energy to run the motor among all the individual motor disc units also reduces the thermal losses. The lower the energy needed to power the stator poles 105 leads to lower electrical resistance losses and results in reduction of heat dissipated from the windings 106. Another implication of this configuration is the lower need of electrical power to produce the same magnitude of the torsional forces as in a single large motor unit with similar dimensions of width and cross sectional diameter. The motor assembly according to the priority invention will reduce dimension and weight parameters with 10% or more, with corresponding performance gain in power to weight ratio.

It should be noted that according to this configuration the rotating magnetic field of the rotor with respect to the static coil windings in the stator facilitates the generation of power from any braking effect and back electromotive force which can be then channeled to any suitable energy source.

The electrical path to feed the control system 1 from the energy source could be separate to that of the energy feedback from the motor to the energy source. The energy feedback mechanism is continuous under operation with the exception of the period when all the stator poles are powered to bring forth the maximum speed/power limit of the motor.

FIG. 107 illustrates the sequence of power flow to and from the motor via the control logic/electronic control system. The control logic may comprise both hardware based logic, microcontrollers and other computing means able to store and execute program code for optimal performance of the motor assembly.

The electrical motor comprises a motor controlling unit which communicates with, and controls, the control logic which is arranged in the stator/rotor assemblies, and further communicate status and instructions to the power source, and also communicates, if present, with a further remote control unit, typically over a wireless network in which case the motor controlling unit also comprises a network communication unit.

The block diagram identifies the control logic 101 being connected to the sensors and the stack of stators. The block diagram further illustrates how power flow is from the power source to the stator stack is controlled by the control logic. Under operation the engine will represent a power generation part composed of negative torque, and back emf collected in the stack of stators. The control units housed in the motor disc maybe controlled, and monitored by a suitable computer.

The invention of the priority application is innovative in several aspects, and the advantages are exemplified by the following aspects.

One aspect of the invention of the priority application is that at any given instant the stator poles 105, 106 which are not energized to produce a rotational mechanical force in the rotor frame 108 is harnessed to produce electrical energy by means of back electromotive force. The magnitude of the power generated in each of the motor disc assembly is a function of the speed of rotation. The necessary magnitude of energy drawn from an energy source varies in accordance to the speed of the motor and is achieved by selectively choosing the necessary number of stator poles via the electronic control logic circuit.

Another aspect of this motor discs assembly is the much lower noise generation during operation.

The power needed to run the motor at a given speed is lower than that of an electric motor of similar size.

Moreover the embodiment of the priority application allows seamless scalability of the motor discs in stacked configuration matching the targeted application.

The stacked motor disc arrangement can provide for physically smaller dimensions than a similar power single cylindrical motor unit, required to run at a similar speed for a given capacity, due to the effective distribution of power among the stator stacks 104 and quicker heat removal from the windings 106.

Having an electronic control system 101 provides enhanced regulation abilities of the flow of power into the stator coils 6 by means of electronically controlled logic which facilitates for the ability to program the logic to provide a flexible power distribution.

Additionally, only the needed power is fed into the stator coils during the period of motor operation for realizing the required torque/speed characteristics, ensuring optimal power usage and increased motor efficiency.

The motor discs may be operated in one or a plurality phase mode for stator excitation where the numbers of stator coils must be either an even number of stator poles in the case of one phase, or any multiple of number of phases where two or more phases are chosen, for example must a 3 phase mode have 3, 6, 9, . . . stator poles. Typically, each phase have at least two stator coils (a pair). For example such that a 3 phase mode have 106 stator poles. The control system 101 is used to monitor and control the drive system. The control system may comprise both hardware based logic, microcontrollers and other computing means able to store and execute program code for optimal performance of the motor assembly.

The electronic control system 101 may also comprise a controlling unit that provides for detecting and prohibiting rapid and sudden power drainage from an energy source into the stator coils 106, which would result in heat production. Detection may be achieved by sensor 121 measurements and/or logic and analysis of the performance parameters of the stator parts in the control logic 1 arranged in the stator or elsewhere. Rapid surge in power to the stator coils could be the result of a malfunctioning motor disc. The effects of a failed motor disc may be reduced substantially, and possibly eliminated, by having the electronic controller inside the stator disc. The motor could still run if it is possible to isolate the failed stator disc(s), as long as one or a critical number of discs of the disc stack required to run the application still operates according to requirements.

The power needed to generate the required torque is reached rapidly in a more controlled fashion without overheating the coils 6. The lesser heat produced in the stator coils and in the whole motor assembly as such in principle may require a smaller capacity fan/blower to effectively reduce the heat in accordance with the targeted application needs.

Another prominent facet according to the priority invention is that there is minimal or none of the electromagnetic interference due to the smooth switching of power to the stator coils.

The electronic control system 101 dictates the maximum current drawn into the stator coils 106, thereby it is possible to provide a safety limit for the stator windings 106.

The electronic control system 101 ensures constant feedback to the motor discs for controlling torque and speed along with mitigation of ripple torque.

The lower heat dissipated from the coils ensures reduced mechanical wear and tear. More importantly the lifetime of the motor is prolonged and potential need for expensive part replacements may be reduced or avoided.

The power generated by the electromagnetic flux between the rotating rotor magnets and the unused stator coils is smoothly and steadily transferred into an energy storage/supply source via the electronic control circuit 101. Herein the electronic control circuit 101 behaves as an intermediary to allow for gradual recharge of the energy storage unit, thereby protecting the energy storage unit from random bursts of power input.

The advantages of scalability of this motor design can be used to readily serve any application ranging from low power tools, small fans, medium sized motors powering automobiles to heavy duty industrial scale motors, ship propulsion engines.

The different aspects and configurations of the possible embodiments and the advantages of which thereof are apparent in the following claims. Furthermore, owing to the changes which might be realized as per this embodiment by those skilled in the art, the scope of the priority invention is not limited to the exact configuration and the operation described here. Therefore any such modifications, equivalents and variants of the priority invention might be taken to fall under the scope of the priority invention according to the following claims.

Some advantageous features of the priority invention can be:
The design of the electric motor disc according to the priority invention may allow for stacking of additional motor discs of similar diameter matching the speed/torque characteristics of the set application.
The design of the electric motor according to the priority invention may use lower input power the run the motor at the required speed.
The design of an electric motor according to the priority invention may be highly scalable and produces higher torque levels for a given input power.
The configuration of an electric motor according to the priority invention may use the power from an energy source channeled to the stator poles via respective electronic control circuitry.
The design of the motor according to the priority invention may allow for controlled power distribution to the coils of the stator poles.
The design of an electric motor according to the priority invention may be highly responsive to the required torque needed for running the motor at a certain speed due to the continual power control monitoring via the electronic control system.
The design of an electric motor according to the priority invention may only energize the required set of stator poles depending on the targeted torque/speed balance.
The design of an electric motor according to the priority invention may generate much lower levels of thermal heat and reduced mechanical wear.
The design of an electric motor according to the priority invention may give rise to reduced acoustic noise levels during the operation due to the lower mechanical friction.
The design of the electric motor according to the priority invention may improve the lifetime of the electric motor without performance degradation.
The design of the electric motor according to the priority invention may prevent the stator coils from sudden surge in input power from an energy source by means of controlled rate of power input channeled via the electronic control system.
The design of the electric motor according to the priority invention may enable the controlled and steady rate of energy storage fed into an appropriate energy storage source from the power generated.
The design of the electric motor according to the priority invention may produce higher torque/speed balance with lower level of energy consumption.
The design of the electric motor according to the priority invention may be readily scaled for the overall diameter of the motor disc, depending on the required output torque/speed needed for the application.
The design of the electric motor according to the priority invention may require no shaft running through the entire central axis of the motor disc.
The design of the electric motor according to the priority invention may have the mechanical power driven from an external shaft arrangement attached in the central part of a capping enclosement fixed to the one end of the rotor ring frame stack arrangement.
The design of the electric motor according to the priority invention may have separate set of cables for drawing and feeding back power from and to an energy storage/supply source respectively.
The design of the electric motor according to the priority invention may produce lower vibration during the motor operation due to the external placement of the rotor frames and rigid placement of the stators in the stack arrangement.
The design of the electric motor according to the priority invention may have the stator energized either by means of a static energy storage source or from a power grid.
The design of the electric motor according to the priority invention may restrict the maximum current limit which can be drawn by the stator by to a preset controlled via the electronic control system, ensuring the safety of the stator coils.
The design of the electric motor according to the priority invention may have the direction of rotation of the rotor determined by setting the direction of polarization of the stator coils via the electronic controller.
The design of the electric motor according to the priority invention may comprise an electronic control system based on a microprocessor or a suitable integrated circuit.
The design of the electric motor according to the priority invention may have a combination of the power driver and controller circuitry in a single integrated circuit.
The design of the electric motor according to the priority invention may minimize the ripple torque effects from the rotor.
The design of the electric motor according to the priority invention may occupy reduced space to drive and control the motor owing to the electronic control embedded into each of the motor disc. This eliminates the need for a further add-on unit with inverter, variable frequency and voltage generator.

A first embodiment of the priority application is further defined to comprise an electric motor comprising a power source, a motor controlling unit, and one or more motor disc assemblies, the motor disc assembly comprising a central part of a stator disc 104 with a set of equidistance spaced stator poles 105 protruding outwards thereof, the stator poles having wounded coils 106 connected to an electronic control system 1 embedded in the central part of the stator disc 104, the control system 1 being connected to the power source and to the motor controlling unit, the motor disc assembly further comprise a rotor ring frame 108 arranged peripherally around the stator disc assembly 101, 104, 105, 106 the rotor ring frame 108 further comprise a set of permanent magnetic cores 107 having a predetermined polarity directed inwardly towards the stator disc assembly 101, 104, 105, 106.

A second embodiment of the priority application comprise an electric motor according to the first embodiment of the priority application, wherein a plurality of motor disc assemblies are arranged together in a motor disc stack where the stator disc assemblies 101, 104, 105, 106 are connected in a fixed arrangement, and the rotor ring assembles 108, 107 are connected in a fixed arrangement.

A third embodiment of the priority application comprise an electric motor according to the first or second embodiment of the priority application, wherein the edges of the rotor ring frames 108 are formed with recesses 119 and protrusions 120 for engaging in a locked manner with the neighbor ring frame 108.

A fourth embodiment of the priority application comprise an electric motor according to any of the previous embodiments of the priority application, wherein the stator disc 104 has predrilled holes 103 for receiving bolts 114, 150 to connect the stator disc assemblies 101, 104, 105, 106 in a locked manner.

A fifth embodiment of the priority application comprise an electric motor according to any of the previous embodiments of the priority application, wherein the stator disc 104 comprises an even number of stator poles 105, and the power source is a one phased power source, and the rotor ring frame 108 comprises corresponding equal number of magnets 107 to the stator poles 105 where each adjacent magnet is arranged with opposite poles 116a,116b directed inwards.

A sixth embodiment of the priority application comprise an electric motor according to any of the first to fourth embodiment of the priority application, wherein the power source is a multiple phased power source, and the number of stator poles 105 is a multiple the number of phases of the feed current through the stator windings 106.

A seventh embodiment of the priority application comprise an electric motor according to the sixth embodiment of the priority application, wherein the magnets 107 comprised in the rotor ring frame 108 are made of irregular shaped soft iron magnetic cores having the inward pointing face width equal or less than the outward facing width of the stator pole 105.

An eighth embodiment of the priority application comprise an electric motor according to any of the previous embodiments of the priority application, wherein the stator poles and the rotor magnetic cores are symmetrically arranged throughout the circumference of the stator disc and rotor ring frame.

A ninth embodiment of the priority application comprise an electric motor according to any of the previous embodiments of the priority application, wherein the electric motor further comprises an recover energy storage for energy recovered by stator coils 106 not used to run the electric motor, the recover energy storage being connected to the control system 101.

A tenth embodiment of the priority application comprise an electric motor according to any of the previous embodiments of the priority application, wherein the control system 101 comprise a switch, where the switch is for connecting the required stator coils to the power source when motor is running, or to the recover energy storage unit when the motor speed slows down/braking.

An eleventh embodiment of the priority application comprise an electric motor according to any of the previous embodiments of the priority application, wherein the control system 101 comprise a controlling unit for preventing the stator coils 106 from sudden surges in input power from the energy source.

A twelfth embodiment of the priority application comprise an electric motor according to any of the previous embodiments of the priority application, wherein the control system 101 comprise an electronic control system being connected to sensors, power sources and power lines.

A thirteenth embodiment of the priority invention application comprise an electric motor according to any of the previous embodiments of the priority application, wherein the control system 101 comprise a controlling unit controlling the power distribution to the coils of the stator poles, such that the electric motor is highly responsive to the required torque needed for running the motor at a certain speed due to the continual power control monitoring via the electronic control system, and only energizes the required set of stator poles depending on the targeted torque/speed balance.

A fourteenth embodiment of the priority application comprise an electric motor according to any of the previous embodiments of the priority application, wherein the rotor disc stack is in one end connected to a solid end disc, the end disc 128 having means for outputting rotational forces from the electric motor.

A fifteenth embodiment of the priority application comprise an electric motor according to any of the previous embodiments of the priority application, wherein the solid end disc 128 is made of a rigid material, such as metal or carbon fiber composite materials.

A sixteenth embodiment of the priority application comprise an electric motor according to the fourteenth or fifteenth embodiments of the priority application, wherein the end disc 128 is formed as a cup encompassing one or more rotor ring frames 108.

A seventeenth embodiment of the priority application comprise an electric motor according to one of the fourteenth, fifteenth or sixteenth embodiments of the priority application, wherein a rotor shaft 122 is arranged centrally and protruding from the end disc 128, outwardly away from the rotor stack.

An eighteenth embodiment of the priority application comprise an electric motor according to any of the fourteenth to seventeenth embodiments of the priority application, wherein the end disc cup 128 is fixedly connected to the rotor ring frames by bolts 151 running through prefabricated holes 109 in the rotor rings.

A nineteenth embodiment of the priority application comprise an electric motor according to any of the previous embodiments of the priority application, wherein the stator disc stack is in one or both ends connected to a stator end disc 133.

A twentieth embodiment of the priority application comprise an electric motor according to any of the previous embodiments of the priority application, wherein the stator end disc 133 is made of a rigid material, such as metal or carbon fiber composite materials.

A twenty-first embodiment of the priority application comprise an electric motor according to the nineteenth or twentieth embodiments of the priority application, wherein the stator end disc 133 in the end pointing towards the rotor end disc, comprising a vibrational attenuation means 124 and a shaft 126 coupling the stator end disc 133 to a bearing arrangement 125 comprised in the rotor shield cup 128.

A twenty-second embodiment of the priority application comprise an electric motor according to the nineteenth, twentieth or twenty-first embodiments of the priority application, wherein the stator end disc 133 in the end pointing away from the rotor end disc, comprising a solid stand 132 for mounting the electric motor and keeping the stator disc stack stationary under operation.

A twenty-third embodiment of the priority application comprise an electric motor according to any of the previous embodiments of the priority application, wherein the stator disc assemblies 101, 104, 105, 106 are fixedly connected by bolts 150 running through prefabricated holes 103 in the stator discs.

A twenty-fourth embodiment of the priority application comprise an electric motor according to any of the previous embodiments of the priority application, wherein the electric motor further comprises a recover energy storage for storing energy recovered from any braking effect and back EMF.

A twenty-fifth embodiment of the priority application comprise an electric motor according to any of the previous embodiments of the priority application, wherein the control system 101 comprise a controlling unit for monitoring and channeling any energy recovered from the back EMF or braking of the motor to the energy source or buffer energy storage unit in a steady, continual manner.

1. An electric generator comprising:
a driving shaft for receiving power from an external power source by being rotated, one or more generator disc assemblies, the generator disc assembly comprising a central part of one or more stator assemblies having outward protruding coil windings, wherein the number of coil windings are a multiple of 2, the generator disc assembly further comprising one or more rotor ring frame assemblies arranged peripherally around the stator disc assembly, wherein the rotor ring frame assembly further comprise a set of magnets being arranged on the inside surface of the rotor ring directed inwardly towards the stator disc assembly, wherein the magnets are arranged such that adjacent magnets have an alternative north-south polarity.

2. The electric generator according to claim 1, wherein the coil windings that are arranged in pairs being arranged opposite each other on the stator disc protruding outwards have opposite polarization.

3. The electric generator according to claim 1, wherein a plurality of generator disc assemblies are arranged together in a generator disc stack where the stator disc assemblies are connected in a fixed arrangement.

4. The electric generator according to claim 1, wherein the number of rotor ring assemblies which are active are adapted to the available power and speed input via the driving shaft.

5. The electric generator according to claim 1, wherein the number of rotor ring assemblies comprise one or more non-active rotor ring assemblies.

6. The electric generator according to claim 5, wherein a non-active rotor ring assembly is defined by being fixedly bound to a first rotor ring by physical means such that it rotates with all the active rotor ring assemblies, but wherein the magnets are non-magnetized electro magnets.

7. The electric generator according to claim 5, wherein a non-active rotor ring assembly is defined by being physically detached from the revolving rotors such that when the active rotor assemblies revolve with the rotating shaft, the non-active rotor assemblies are kept static at rest.

8. The electric generator according to claim 7, wherein magnets in the rotor assemblies are electro magnets.

9. The electric generator according to claim 7, wherein magnets in the rotor assemblies are permanent magnets.

10. The electric generator according to claim 1, wherein the edges of the rotor ring frames are formed with recesses and protrusions for engaging in a locked manner with the neighbor ring frame.

11. The electric generator according to claim 1, wherein the stator disc has predrilled holes for receiving bolts to connect the stator disc assemblies in a locked manner.

12. The electric generator according to claim 1, wherein the stator disc comprises one or more set of coil windings, each set corresponding to a unique phase of power generation, and the rotor ring frame comprises of a number of electromagnets facing the stator coils where each adjacent magnet is arranged with opposite poles directed inwards.

13. The electric generator according claim 1, wherein the rotor magnetic cores are symmetrically arranged throughout the circumference of the stator disc and rotor ring frame.

14. The electric generator according to claim 1, wherein the electric generator further comprises a recover energy storage in addition to the supply cables to the grid for storing a small fraction of generated power.

15. The electric generator according to claim 1, wherein the addition/removal of rotor discs to the fixed rotor assembly is relative to the increase/decrease in the speed of the turbine.

16. The electric generator according to claim 1, wherein the rotor disc stack is in one end connected to a solid end disc, the end disc has means for transferring the rotational forces from the turbine to rotors of the electric generator.

17. The electric generator according to claim 1, wherein the solid end disc is made of a rigid material, such as metal or carbon fiber composite materials.

18. The electric generator according to claim 1, wherein the end disc is joined with holding bars having weighted clamps to hold two or more rotor ring frames.

19. The electric generator according to claim 1, wherein a rotor shaft is arranged centrally and protruding from the end disc, outwardly away from the rotor stack.

20. The electric generator according to claim 1, wherein the stator disc stack is in one or both ends connected to a stator end disc.

21. The electric generator according to claim 1, wherein the stator end disc is made of a rigid material, such as metal or carbon fiber composite materials.

22. The electric generator according to claim 1, wherein the stator end disc in the end pointing towards the rotor end disc, comprising a vibrational attenuation means and a shaft coupling the stator end disc to a bearing arrangement comprised in the rotor shield cup.

23. The electric generator according to claim 1, wherein the stator end disc in the end pointing away from the rotor end disc, comprising a solid stand for mounting the electric generator and keeping the stator disc stack stationary under operation.

24. The electric generator according to claim 1, wherein the stator disc assemblies are fixedly connected by bolts running through prefabricated holes in the stator discs.

25. A method for operating an electrical generator as defined in in claim 1, the method comprising the following steps:
providing the generator controlling unit with instructions for running the electrical generator,
the generator controlling unit communicating with each control unit in the stator disc array, where each control unit controls the operation of the individual stator coils of respective stator disc as instructed,
retrieving power through all stator windings when torque is applied to the rotors, and storing it at an energy storage,
providing necessary power supply to the electrical generator from either an energy storage or from the power generating stator windings.

26. The system for an electrical generator assembly according to claim 1, comprising a generator controlling unit, a host for controlling the electrical generator assembly, and connecting device connecting the electrical generator assembly to an energy storage or electrical grid system.

27. The system according to claim 26, wherein the host is a wind turbine.

28. The system according to claim 27, wherein the generator controlling unit is connected to a weather forecast resource in order for adapting the generator assembly characteristics in accordance with forecasted wind speeds.
